(19) United States
(12) Patent Application Publication
(10) Pub. No.: US 2019/0349589 A1
(43) Pub. Date: Nov. 14, 2019

(54) IMAGE PROCESSING METHOD BASED ON INTER PREDICTION MODE, AND APPARATUS THEREFOR

(71) Applicant: LG ELECTRONICS INC., Seoul (KR)

(72) Inventor: Jaeho LEE, Seoul (KR)

(21) Appl. No.: 16/474,939

(22) PCT Filed: Dec. 28, 2016
(86) PCT No.: PCT/KR2016/015407

§ 371 Date: Jun. 28, 2019

(51) Int. Cl. H04N 19/159; H04N 19/105; H04N 19/139; H04N 19/176

(52) U.S. Cl. CPC H04N 19/159; H04N 19/176; H04N 19/139; H04N 19/105

(57) ABSTRACT

The present invention discloses a method and an apparatus for processing an image based on an inter prediction mode. Specifically, a method for processing an image based on an inter prediction may include: generating a bi-directional predictor of a current pixel in a current block by performing a bi-directional inter prediction based on a motion vector of the current block; adaptively determining a window area centered on a pixel having a pixel having a collocated coordinate with the current pixel in a first reference block and a second reference block of the current block; deriving one motion vector in the window area by using a gradient indicating an increase/decrease rate of a pixel value in a horizontal direction or a vertical direction based on each pixel of the window area and determining the derived motion vector as a pixel-unit motion vector of the current pixel; and generating a predictor of the current pixel by adjusting the bi-directional predictor based on the pixel-unit motion vector.

### CROSS-REFERENCE TO RELATED APPLICATIONS

This application is the National Stage filing under 35 U.S.C. 371 of International Application No. PCT/KR2016/015407, filed on Dec. 28, 2016, and the contents of which are all hereby incorporated by reference herein in their entirety.

### TECHNICAL FIELD

The present invention relates to a method of processing a still image or a moving image and, more particularly, to a method of encoding/decoding a still image or a moving image based on an inter-prediction mode and an apparatus supporting the same.

### BACKGROUND ART

Compression encoding means a series of signal processing techniques for transmitting digitized information through a communication line or techniques for storing information in a form suitable for a storage medium. The medium including a picture, an image, audio, etc. may be a target for compression encoding, and particularly, a technique for performing compression encoding on a picture is referred to as video image compression.

Next-generation video contents are supposed to have the characteristics of high spatial resolution, a high frame rate and high dimensionality of scene representation. In order to process such contents, a drastic increase in the memory storage, memory access rate and processing power will result.

Accordingly, it is required to design a coding tool for processing next-generation video contents efficiently.

### DISCLOSURE

### Technical Problem

An object of the present invention proposes a method for performing pixel unit motion compensation by using a window other than an outlier in order to enhance accuracy of pixel unit motion prediction as compared with an existing bi-directional optical (BIO) flow method.

Further, an object of the present invention proposes a method for adaptively adjusting a size of a window according to a size or a form of a block in order to enhance accuracy of pixel unit motion prediction.

Further, an object of the present invention proposes a method for designing a window having a weighting function by giving a weight depending on a distance from a distance from a central pixel in the window.

Technical objects to be achieved in the present invention are not limited to the aforementioned technical objects, and other technical objects not described above may be evidently understood by a person having ordinary skill in the art to which the present invention pertains from the following description.

### Technical Solution

In an aspect, a method for processing an image based on an inter prediction may include: generating a bi-directional predictor of a current pixel in a current block by performing a bi-directional inter prediction based on a motion vector of the current block; adaptively determining a window area centered on a pixel having a pixel having a collocated coordinate with the current pixel in a first reference block and a second reference block of the current block; deriving one motion vector in the window area by using a gradient indicating an increase/decrease rate of a pixel value in a horizontal direction or a vertical direction based on each pixel of the window area and determining the derived motion vector as a pixel-unit motion vector of the current pixel; and generating a predictor of the current pixel by adjusting the bi-directional predictor based on the pixel-unit motion vector.

In an aspect, an apparatus for processing an image based on an inter prediction may include: a bi-directional predictor generation unit generating a bi-directional predictor of a current pixel in a current block by performing a bi-directional inter prediction based on a motion vector of the current block; a window area determination unit adaptively determining a window area centered on a pixel having a pixel having a collocated coordinate with the current pixel in a first reference block and a second reference block of the current block; a pixel-unit motion vector determination unit deriving one motion vector in the window area by using a gradient indicating an increase/decrease rate of a pixel value in a horizontal direction or a vertical direction based on each pixel of the window area and determining the derived motion vector as a pixel-unit motion vector of the current pixel; and a pixel-unit predictor generation unit generating a predictor of the current pixel by adjusting the bi-directional predictor based on the pixel-unit motion vector.

Preferably, the adaptively determining of the window area may further include determining a pixel in which a difference between a gradient and a representative value of a gradient having an area having a predetermined size exceeds a specific threshold value among pixels in the area having the predetermined size centered on the current pixel, and the window area may be determined as an area from which the pixel in which the difference exceeds the threshold value in the area having the predetermined size is excluded.

Preferably, the representative value of the gradient of the area having the predetermined size may be any one of a mean value of the gradient of each pixel having the area having the predetermined size, a median value of the gradient of each pixel of the area having the predetermined size, and a gradient of a central pixel of the area having the predetermined size.

Preferably, in the determining of the pixel in which the difference exceeds the specific threshold value, the pixel in which the difference exceeds the specific threshold value may be determined except for a part duplicated with the area having the predetermined size centered on a pixel adjacent to the current pixel from the area having the predetermined size centered on the current pixel.

Preferably, the window area may be determined as an area having a predefined size according to the size of the current block.

Preferably, the window area may be determined as an area having any one size of 3×3, 5×5, and 7×7 according to the size of the current block.

Preferably, the window area is determined as an area having a predefined form according to the form of the current block.

Preferably, when the current block is a non-square block, the window area may be determined as a non-square area.

Preferably, the pixel-unit motion vector may be derived from the gradient of each pixel to which a weight depending on a distance from the central pixel of the window area is granted.

### Advantageous Effects

According to an embodiment of the present invention, accuracy of prediction can be enhanced as compared with the existing method by performing optical flow based motion compensation (or pixel unit motion compensation) by using a window area other than an outlier.

Further, according to an embodiment of the present invention, a size of a window is adaptively adjusted by a size of a window according to a size or a form of a partitioned block by reflecting characteristics of an image to effectively reflect a motion in the image and increase accuracy of prediction.

Technical effects which may be obtained in the present invention are not limited to the technical effects described above, and other technical effects not mentioned herein may be understood to those skilled in the art from the description below.

### DESCRIPTION OF DRAWINGS

The accompanying drawings, which are included herein as a part of the description for help understanding the present invention, provide embodiments of the present invention, and describe the technical features of the present invention with the description below.

FIG. 1 is illustrates a schematic block diagram of an encoder in which the encoding of a still image or video signal is performed, as an embodiment to which the present invention is applied.

FIG. 2 illustrates a schematic block diagram of a decoder in which decoding of a still image or video signal is performed, as an embodiment to which the present invention is applied.

FIG. 3 is a diagram for describing a split structure of a coding unit that may be applied to the present invention.

FIG. 4 is a diagram for describing a prediction unit that may be applied to the present invention.

FIG. 5 is an embodiment to which the present invention may be applied and is a diagram illustrating the direction of inter-prediction.

FIG. 6 is an embodiment to which the present invention may be applied and illustrates integers for ¼ sample interpolation and a fraction sample locations.

FIG. 7 is an embodiment to which the present invention may be applied and illustrates the location of a spatial candidate.

FIG. 8 is an embodiment to which the present invention is applied and is a diagram illustrating an inter-prediction method.

FIG. 9 is an embodiment to which the present invention may be applied and is a diagram illustrating a motion compensation process.

FIG. 10 illustrates a bi-directional prediction method of a picture having a steady motion as an embodiment to which the present invention may be applied.

FIG. 11 is a diagram illustrating a motion compensation method through the bi-directional prediction according to an embodiment of the present invention.

FIG. 12 is a diagram illustrating a method for determining a gradient map according to an embodiment of the present invention.

FIG. 13 is a diagram illustrating a method of determining an optical flow motion vector according to an embodiment of the present invention.

FIG. 14 is a diagram illustrating a method for compensating a motion through bi-directional prediction according to an embodiment of the present invention.

FIG. 15 is a diagram for describing a method for removing an outlier in a window area as an embodiment to which the present invention may be applied.

FIG. 16 is a diagram for describing a method for removing an outlier in a window area as an embodiment to which the present invention may be applied.

FIG. 17 is a diagram illustrating a method for applying a weight in a window area as an embodiment to which the present invention may be applied.

FIG. 18 is a diagram illustrating a method for applying a weight in a window area as an embodiment to which the present invention may be applied.

FIG. 19 is a diagram illustrating an inter prediction based image processing method according to an embodiment of the present invention.

FIG. 20 is a diagram illustrating an inter prediction unit according to an embodiment of the present invention.

### MODE FOR INVENTION

Hereinafter, a preferred embodiment of the present invention will be described by reference to the accompanying drawings. The description that will be described below with the accompanying drawings is to describe exemplary embodiments of the present invention, and is not intended to describe the only embodiment in which the present invention may be implemented. The description below includes particular details in order to provide perfect understanding of the present invention. However, it is understood that the present invention may be embodied without the particular details to those skilled in the art.

In some cases, in order to prevent the technical concept of the present invention from being unclear, structures or devices which are publicly known may be omitted, or may be depicted as a block diagram centering on the core functions of the structures or the devices.

Further, although general terms widely used currently are selected as the terms in the present invention as much as possible, a term that is arbitrarily selected by the applicant is used in a specific case. Since the meaning of the term will be clearly described in the corresponding part of the description in such a case, it is understood that the present invention will not be simply interpreted by the terms only used in the description of the present invention, but the meaning of the terms should be figured out.

Specific terminologies used in the description below may be provided to help the understanding of the present invention. Furthermore, the specific terminology may be modified into other forms within the scope of the technical concept of the present invention. For example, a signal, data, a sample, a picture, a frame, a block, etc may be properly replaced and interpreted in each coding process.

Hereinafter, in this specification, a “processing unit” means a unit in which an encoding/decoding processing process, such as prediction, transform and/or quantization, is performed. Hereinafter, for convenience of description, a processing unit may also be called “processing block” or “block.”

A processing unit may be construed as having a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as being a unit for a luma component or a unit for a chroma component. For example, the processing unit may correspond to a coding tree block (CTB), coding block (CB), prediction block (PB) or transform block (TB) for a luma component. Alternatively, a processing unit may correspond to a coding tree block (CTB), coding block (CB), prediction block (PU) or transform block (TB) for a chroma component. Also, the present invention is not limited to this, and the processing unit may be interpreted to include a unit for the luma component and a unit for the chroma component.

Furthermore, a processing unit is not essentially limited to a square block and may be constructed in a polygon form having three or more vertices.

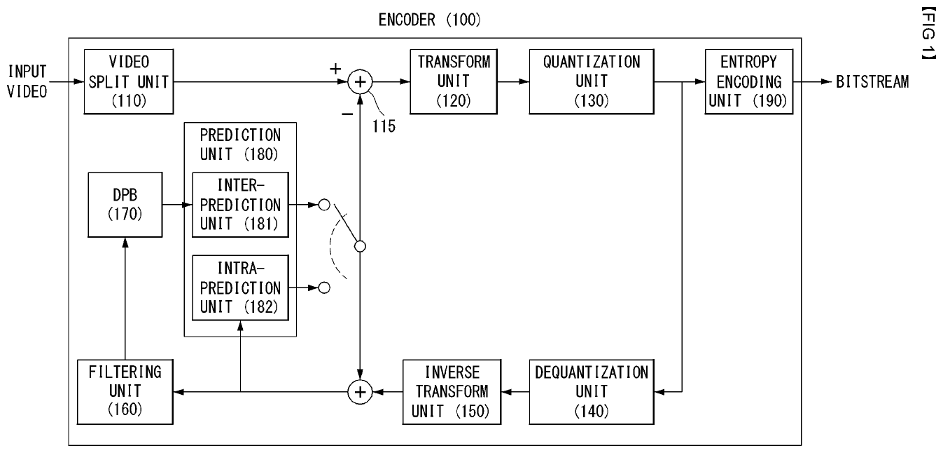

FIG. 1 is illustrates a schematic block diagram of an encoder in which the encoding of a still image or video signal is performed, as an embodiment to which the present invention is applied.

Referring to FIG. 1, the encoder 100 may include a video split unit 110, a subtractor 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., by the inter-prediction unit 181 or the intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate transform coefficients by performing transform using a prediction mode applied to the residual block and a transform scheme determined based on the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal outputted by the quantization unit 130 may be used to generate a prediction signal. For example, a residual signal may be reconstructed by applying dequatization and inverse transformation to the quantized signal through the dequantization unit 140 and the inverse transform unit 150. A reconstructed signal may be generated by adding the reconstructed residual signal to the prediction signal output by the inter-prediction unit 181 or the intra-prediction unit 182.

Meanwhile, during such a compression process, neighbor blocks are quantized by different quantization parameters. Accordingly, an artifact in which a block boundary is shown may occur. Such a phenomenon is referred to a blocking artifact, which is one of important factors for evaluating image quality. In order to decrease such an artifact, a filtering process may be performed. Through such a filtering process, the blocking artifact is removed and the error of a current picture is decreased at the same time, thereby improving image quality.

The filtering unit 160 applies filtering to the reconstructed signal, and outputs it through a playback device or transmits it to the decoded picture buffer 170. The filtered signal transmitted to the decoded picture buffer 170 may be used as a reference picture in the inter-prediction unit 181. As described above, an encoding rate as well as image quality can be improved using the filtered picture as a reference picture in an inter-picture prediction mode.

The decoded picture buffer 170 may store the filtered picture in order to use it as a reference picture in the inter-prediction unit 181.

The inter-prediction unit 181 performs temporal prediction and/or spatial prediction with reference to the reconstructed picture in order to remove temporal redundancy and/or spatial redundancy.

In this case, a blocking artifact or ringing artifact may occur because a reference picture used to perform prediction is a transformed signal that experiences quantization or dequantization in a block unit when it is encoded/decoded previously.

Accordingly, in order to solve performance degradation attributable to the discontinuity of such a signal or quantization, signals between pixels may be interpolated in a sub-pixel unit by applying a low pass filter to the inter-prediction unit 181. In this case, the sub-pixel means a virtual pixel generated by applying an interpolation filter, and an integer pixel means an actual pixel that is present in a reconstructed picture. A linear interpolation, a bi-linear interpolation, a wiener filter, and the like may be applied as an interpolation method.

The interpolation filter may be applied to the reconstructed picture, and may improve the accuracy of prediction. For example, the inter-prediction unit 181 may perform prediction by generating an interpolation pixel by applying the interpolation filter to the integer pixel and by using the interpolated block including interpolated pixels as a prediction block.

The intra-prediction unit 182 predicts a current block with reference to samples neighboring the block that is now to be encoded. The intra-prediction unit 182 may perform the following procedure in order to perform intra-prediction. First, the intra-prediction unit 182 may prepare a reference sample necessary to generate a prediction signal. Furthermore, the intra-prediction unit 182 may generate a prediction signal using the prepared reference sample. Next, the intra-prediction unit 182 may encode a prediction mode. In this case, the reference sample may be prepared through reference sample padding and/or reference sample filtering. A quantization error may be present because the reference sample experiences the prediction and the reconstruction process. Accordingly, in order to reduce such an error, a reference sample filtering process may be performed on each prediction mode used for the intra-prediction.

The prediction signal (or prediction block) generated through the inter-prediction unit 181 or the intra-prediction unit 182 may be used to generate a reconstructed signal (or reconstructed block) or may be used to generate a residual signal (or residual block).

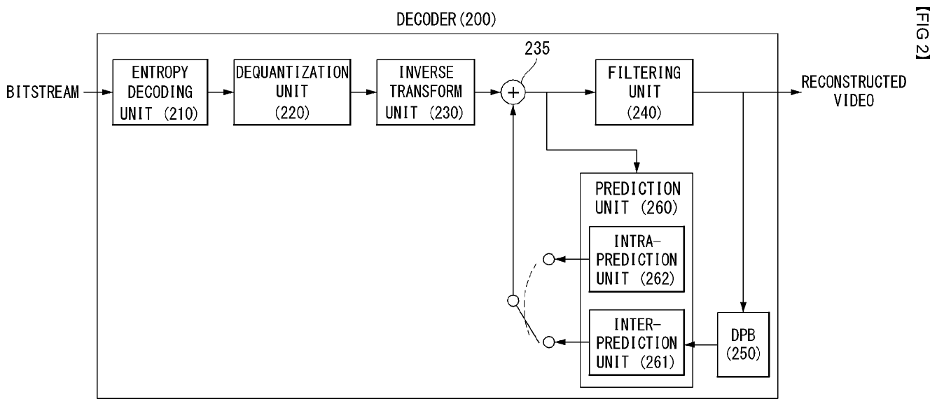

FIG. 2 illustrates a schematic block diagram of a decoder in which decoding of a still image or video signal is performed, as an embodiment to which the present invention is applied.

Referring to FIG. 2, the decoder 200 may include an entropy decoding unit 210, a dequantization unit 220, an inverse transform unit 230, an adder 235, a filtering unit 240, a decoded picture buffer (DPB) 250 and a prediction unit 260.

Furthermore, the prediction unit 260 may include an inter-prediction unit 261 and an intra-prediction unit 262.

Furthermore, a reconstructed video signal output through the decoder 200 may be played back through a playback device.

The decoder 200 receives a signal (i.e., bit stream) output by the encoder 100 shown in FIG. 1. The entropy decoding unit 210 performs an entropy decoding operation on the received signal.

The dequantization unit 220 obtains transform coefficients from the entropy-decoded signal using quantization step size information.

The inverse transform unit 230 obtains a residual signal (or residual block) by inverse transforming the transform coefficients by applying an inverse transform scheme.

The adder 235 adds the obtained residual signal (or residual block) to the prediction signal (or prediction block) output by the prediction unit 260 (i.e., the inter-prediction unit 261 or the intra-prediction unit 262), thereby generating a reconstructed signal (or reconstructed block).

The filtering unit 240 applies filtering to the reconstructed signal (or reconstructed block) and outputs the filtered signal to a playback device or transmits the filtered signal to the decoded picture buffer 250. The filtered signal transmitted to the decoded picture buffer 250 may be used as a reference picture in the inter-prediction unit 261.

In this specification, the embodiments described in the filtering unit 160, inter-prediction unit 181 and intra-prediction unit 182 of the encoder 100 may be identically applied to the filtering unit 240, inter-prediction unit 261 and intra-prediction unit 262 of the decoder, respectively.

Processing Unit Split Structure

In general, a block-based image compression method is used in the compression technique (e.g., HEVC) of a still image or a video. The block-based image compression method is a method of processing an image by splitting it into specific block units, and may decrease memory use and a computational load.

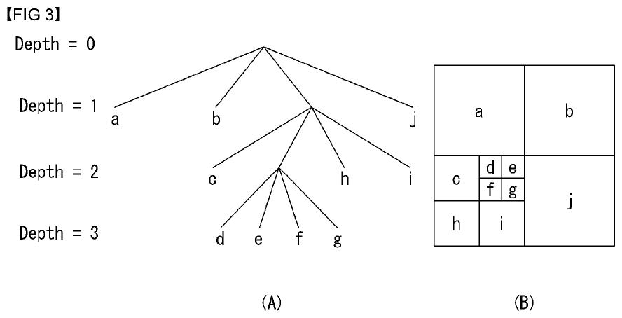

FIG. 3 is a diagram for describing a split structure of a coding unit which may be applied to the present invention.

An encoder splits a single image (or picture) into coding tree units (CTUs) of a quadrangle form, and sequentially encodes the CTUs one by one according to raster scan order.

In HEVC, a size of CTU may be determined as one of 64×64, 32×32, and 16×16. The encoder may select and use the size of a CTU based on resolution of an input video signal or the characteristics of input video signal. The CTU includes a coding tree block (CTB) for a luma component and the CTB for two chroma components that correspond to it.

One CTU may be split in a quad-tree structure. That is, one CTU may be split into four units each having a square form and having a half horizontal size and a half vertical size, thereby being capable of generating coding units (CUs). Such splitting of the quad-tree structure may be recursively performed. That is, the CUs are hierarchically split from one CTU in the quad-tree structure.

A CU means a basic unit for the processing process of an input video signal, for example, coding in which intra/inter prediction is performed. A CU includes a coding block (CB) for a luma component and a CB for two chroma components corresponding to the luma component. In HEVC, a CU size may be determined as one of 64×64, 32×32, 16×16, and 8×8.

Referring to FIG. 3, the root node of a quad-tree is related to a CTU. The quad-tree is split until a leaf node is reached. The leaf node corresponds to a CU.

This is described in more detail. The CTU corresponds to the root node and has the smallest depth (i.e., depth=0) value. A CTU may not be split depending on the characteristics of an input video signal. In this case, the CTU corresponds to a CU.

A CTU may be split in a quad-tree form. As a result, lower nodes, that is, a depth 1 (depth=1), are generated. Furthermore, a node (i.e., leaf node) that belongs to the lower nodes having the depth of 1 and that is no longer split corresponds to a CU. For example, in FIG. 3(b), a CU(a), a CU(b) and a CU(j) corresponding to nodes a, b and j have been once split from the CTU, and have a depth of 1.

At least one of the nodes having the depth of 1 may be split in a quad-tree form. As a result, lower nodes having a depth 1 (i.e., depth=2) are generated. Furthermore, a node (i.e., leaf node) that belongs to the lower nodes having the depth of 2 and that is no longer split corresponds to a CU. For example, in FIG. 3(b), a CU(c), a CU(h) and a CU(i) corresponding to nodes c, h and i have been twice split from the CTU, and have a depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a CU(d), a CU(e), a CU(f) and a CU(g) corresponding to nodes d, e, f and g have been three times split from the CTU, and have a depth of 3.

In the encoder, a maximum size or minimum size of a CU may be determined based on the characteristics of a video image (e.g., resolution) or by considering the encoding rate. Furthermore, information about the maximum or minimum size or information capable of deriving the information may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents a split count and/or degree of a CU, it may include information about the size of a CU.

Since the LCU is split in a Quad-tree shape, the size of SCU may be obtained by using a size of LCU and the maximum depth information. Or, inversely, the size of LCU may be obtained by using a size of SCU and the maximum depth information of the tree.

For a single CU, the information (e.g., a split CU flag (split_cu_flag)) that represents whether the corresponding CU is split may be forwarded to the decoder. This split information is included in all CUs except the SCU. For example, when the value of the flag that represents whether to split is ‘1’, the corresponding CU is further split into four CUs, and when the value of the flag that represents whether to split is ‘0’, the corresponding CU is not split any more, and the processing process for the corresponding CU may be performed.

As described above, a CU is a basic unit of the coding in which the intra-prediction or the inter-prediction is performed. The HEVC splits the CU in a prediction unit (PU) for coding an input video signal more effectively.

A PU is a basic unit for generating a prediction block, and even in a single CU, the prediction block may be generated in different way by a unit of PU. However, the intra-prediction and the inter-prediction are not used together for the PUs that belong to a single CU, and the PUs that belong to a single CU are coded by the same prediction method (i.e., the intra-prediction or the inter-prediction).

A PU is not split in the Quad-tree structure, but is split once in a single CU in a predetermined shape. This will be described by reference to the drawing below.

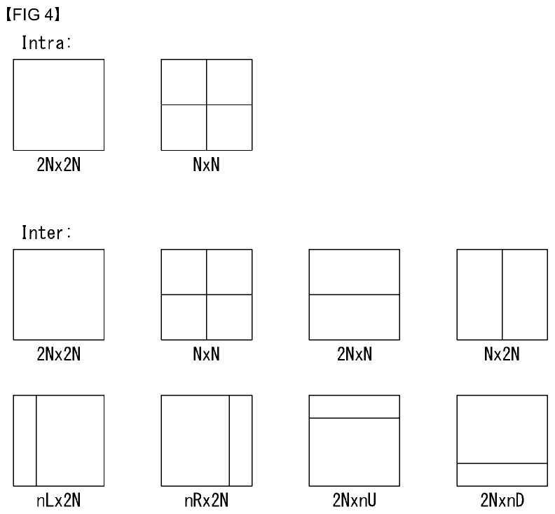

FIG. 4 is a diagram for describing a prediction unit that may be applied to the present invention.

A PU is differently split depending on whether the intra-prediction mode is used or the inter-prediction mode is used as the coding mode of the CU to which the PU belongs.

FIG. 4(a) illustrates a PU if the intra-prediction mode is used, and FIG. 4(b) illustrates a PU if the inter-prediction mode is used.

Referring to FIG. 4(a), assuming that the size of a single CU is 2N×2N (N=4, 8, 16 and 32), the single CU may be split into two types (i.e., 2N×2N or N×N).

In this case, if a single CU is split into the PU of 2N×2N shape, it means that only one PU is present in a single CU.

Meanwhile, if a single CU is split into the PU of N×N shape, a single CU is split into four PUs, and different prediction blocks are generated for each PU unit. However, such PU splitting may be performed only if the size of CB for the luma component of CU is the minimum size (i.e., the case that a CU is an SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in the intra-prediction, the PU split of N×N shape may be performed only if the size of CB for the luma component of CU is the minimum size (i.e., the case that a CU is an SCU).

The inter-prediction supports the PU split in the shape of 2N×N that is split in a horizontal direction and in the shape of N×2N that is split in a vertical direction.

In addition, the inter-prediction supports the PU split in the shape of nL×2N, nR×2N, 2N×nU and 2N×nD, which is an asymmetric motion split (AMP). In this case, ‘n’ means ¼ value of 2N. However, the AMP may not be used if the CU to which the PU is belonged is the CU of minimum size.

In order to encode the input video signal in a single CTU efficiently, the optimal split structure of the coding unit (CU), the prediction unit (PU) and the transform unit (TU) may be determined based on a minimum rate-distortion value through the processing process as follows. For example, as for the optimal CU split process in a 64×64 CTU, the rate-distortion cost may be calculated through the split process from a CU of 64×64 size to a CU of 8×8 size. The detailed process is as follows.

1) The optimal split structure of a PU and TU that generates the minimum rate distortion value is determined by performing inter/intra-prediction, transformation/quantization, dequantization/inverse transformation and entropy encoding on the CU of 64×64 size.

2) The optimal split structure of a PU and TU is determined to split the 64×64 CU into four CUs of 32×32 size and to generate the minimum rate distortion value for each 32×32 CU.

3) The optimal split structure of a PU and TU is determined to further split the 32×32 CU into four CUs of 16×16 size and to generate the minimum rate distortion value for each 16×16 CU.

4) The optimal split structure of a PU and TU is determined to further split the 16×16 CU into four CUs of 8×8 size and to generate the minimum rate distortion value for each 8×8 CU.

5) The optimal split structure of a CU in the 16×16 block is determined by comparing the rate-distortion value of the 16×16 CU obtained in the process 3) with the addition of the rate-distortion value of the four 8×8 CUs obtained in the process 4). This process is also performed for remaining three 16×16 CUs in the same manner.

6) The optimal split structure of CU in the 32×32 block is determined by comparing the rate-distortion value of the 32×32 CU obtained in the process 2) with the addition of the rate-distortion value of the four 16×16 CUs that is obtained in the process 5). This process is also performed for remaining three 32×32 CUs in the same manner.

7) Finally, the optimal split structure of CU in the 64×64 block is determined by comparing the rate-distortion value of the 64×64 CU obtained in the process 1) with the addition of the rate-distortion value of the four 32×32 CUs obtained in the process 6).

In the intra-prediction mode, a prediction mode is selected as a PU unit, and prediction and reconstruction are performed on the selected prediction mode in an actual TU unit.

A TU means a basic unit in which actual prediction and reconstruction are performed. A TU includes a transform block (TB) for a luma component and a TB for two chroma components corresponding to the luma component.

In the example of FIG. 3, as in an example in which one CTU is split in the quad-tree structure to generate a CU, a TU is hierarchically split from one CU to be coded in the quad-tree structure.

TUs split from a CU may be split into smaller and lower TUs because a TU is split in the quad-tree structure. In HEVC, the size of a TU may be determined to be as one of 32×32, 16×16, 8×8 and 4×4.

Referring back to FIG. 3, the root node of a quad-tree is assumed to be related to a CU. The quad-tree is split until a leaf node is reached, and the leaf node corresponds to a TU.

This is described in more detail. A CU corresponds to a root node and has the smallest depth (i.e., depth=0) value. A CU may not be split depending on the characteristics of an input image. In this case, the CU corresponds to a TU.

A CU may be split in a quad-tree form. As a result, lower nodes having a depth 1 (depth=1) are generated. Furthermore, a node (i.e., leaf node) that belongs to the lower nodes having the depth of 1 and that is no longer split corresponds to a TU. For example, in FIG. 3(b), a TU(a), a TU(b) and a TUU) corresponding to the nodes a, b and j are once split from a CU and have a depth of 1.

At least one of the nodes having the depth of 1 may be split in a quad-tree form again. As a result, lower nodes having a depth 2 (i.e., depth=2) are generated. Furthermore, a node (i.e., leaf node) that belongs to the lower nodes having the depth of 2 and that is no longer split corresponds to a TU. For example, in FIG. 3(b), a TU(c), a TU(h) and a TU(i) corresponding to the node c, h and i have been split twice from the CU and have the depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a TU(d), a TU(e), a TU(f) and a TU(g) corresponding to the nodes d, e, f and g have been three times split from the CU and have the depth of 3.

A TU having a tree structure may be hierarchically split with predetermined maximum depth information (or maximum level information). Furthermore, each spit TU may have depth information. The depth information may include information about the size of the TU because it indicates the split number and/or degree of the TU.

Information (e.g., a split TU flag “split_transform_flag”) indicating whether a corresponding TU has been split with respect to one TU may be transferred to the decoder. The split information is included in all of TUs other than a TU of a minimum size. For example, if the value of the flag indicating whether a TU has been split is “1”, the corresponding TU is split into four TUs. If the value of the flag indicating whether a TU has been split is “0”, the corresponding TU is no longer split.

Prediction

In order to reconstruct a current processing unit on which decoding is performed, the decoded part of a current picture or other pictures including the current processing unit may be used.

A picture (slice) using only a current picture for reconstruction, that is, on which only intra-prediction is performed, may be called an intra-picture or I picture (slice), a picture (slice) using a maximum of one motion vector and reference index in order to predict each unit may be called a predictive picture or P picture (slice), and a picture (slice) using a maximum of two motion vector and reference indices may be called a bi-predictive picture or B a picture (slice).

Intra-prediction means a prediction method of deriving a current processing block from the data element (e.g., a sample value) of the same decoded picture (or slice). That is, intra-prediction means a method of predicting the pixel value of a current processing block with reference to reconstructed regions within a current picture.

Hereinafter, inter-prediction is described in more detail.

Inter-Prediction (or Inter-Frame Prediction)

Inter-prediction means a prediction method of deriving a current processing block based on the data element (e.g., sample value or motion vector) of a picture other than a current picture. That is, inter-prediction means a method of predicting the pixel value of a current processing block with reference to reconstructed regions within another reconstructed picture other than a current picture.

Inter-prediction (or inter-picture prediction) is a technology for removing redundancy present between pictures and is chiefly performed through motion estimation and motion compensation.

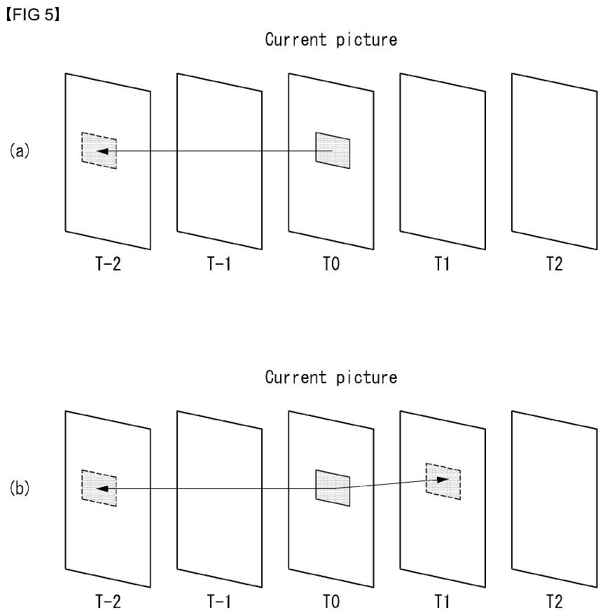

FIG. 5 is an embodiment to which the present invention may be applied and is a diagram illustrating the direction of inter-prediction.

Referring to FIG. 5, inter-prediction may be divided into uni-direction prediction in which only one past picture or future picture is used as a reference picture on a time axis with respect to a single block and bi-directional prediction in which both the past and future pictures are referred at the same time.

Furthermore, the uni-direction prediction may be divided into forward direction prediction in which a single reference picture temporally displayed (or output) prior to a current picture is used and backward direction prediction in which a single reference picture temporally displayed (or output) after a current picture is used.

In the inter-prediction process (i.e., uni-direction or bi-directional prediction), a motion parameter (or information) used to specify which reference region (or reference block) is used in predicting a current block includes an inter-prediction mode (in this case, the inter-prediction mode may indicate a reference direction (i.e., uni-direction or bidirectional) and a reference list (i.e., L0, L1 or bidirectional)), a reference index (or reference picture index or reference list index), and motion vector information. The motion vector information may include a motion vector, motion vector prediction (MVP) or a motion vector difference (MVD). The motion vector difference means a difference between a motion vector and a motion vector predictor.

In the uni-direction prediction, a motion parameter for one-side direction is used. That is, one motion parameter may be necessary to specify a reference region (or reference block).

In the bi-directional prediction, a motion parameter for both directions is used. In the bi-directional prediction method, a maximum of two reference regions may be used. The two reference regions may be present in the same reference picture or may be present in different pictures. That is, in the bi-directional prediction method, a maximum of two motion parameters may be used. Two motion vectors may have the same reference picture index or may have different reference picture indices. In this case, the reference pictures may be displayed temporally prior to a current picture or may be displayed (or output) temporally after a current picture.

The encoder performs motion estimation in which a reference region most similar to a current processing block is searched for in reference pictures in an inter-prediction process. Furthermore, the encoder may provide the decoder with a motion parameter fora reference region.

The encoder/decoder may obtain the reference region of a current processing block using a motion parameter. The reference region is present in a reference picture having a reference index. Furthermore, the pixel value or interpolated value of a reference region specified by a motion vector may be used as the predictor of a current processing block. That is, motion compensation in which an image of a current processing block is predicted from a previously decoded picture is performed using motion information.

In order to reduce the transfer rate related to motion vector information, a method of obtaining a motion vector predictor (mvd) using motion information of previously decoded blocks and transmitting only the corresponding difference (mvd) may be used. That is, the decoder calculates the motion vector predictor of a current processing block using motion information of other decoded blocks and obtains a motion vector value for the current processing block using a difference from the encoder. In obtaining the motion vector predictor, the decoder may obtain various motion vector candidate values using motion information of other already decoded blocks, and may obtain one of the various motion vector candidate values as a motion vector predictor.

—Reference Picture Set and Reference Picture List

In order to manage multiple reference pictures, a set of previously decoded pictures are stored in the decoded picture buffer (DPB) for the decoding of the remaining pictures.

A reconstructed picture that belongs to reconstructed pictures stored in the DPB and that is used for inter-prediction is called a reference picture. In other words, a reference picture means a picture including a sample that may be used for inter-prediction in the decoding process of a next picture in a decoding sequence.

A reference picture set (RPS) means a set of reference pictures associated with a picture, and includes all of previously associated pictures in the decoding sequence. A reference picture set may be used for the inter-prediction of an associated picture or a picture following a picture in the decoding sequence. That is, reference pictures retained in the decoded picture buffer (DPB) may be called a reference picture set. The encoder may provide the decoder with a sequence parameter set (SPS) (i.e., a syntax structure having a syntax element) or reference picture set information in each slice header.

A reference picture list means a list of reference pictures used for the inter-prediction of a P picture (or slice) or a B picture (or slice). In this case, the reference picture list may be divided into two reference pictures lists, which may be called a reference picture list 0 (or L0) and a reference picture list 1 (or L1). Furthermore, a reference picture belonging to the reference picture list 0 may be called a reference picture 0 (or L0 reference picture), and a reference picture belonging to the reference picture list 1 may be called a reference picture 1 (or L1 reference picture).

In the decoding process of the P picture (or slice), one reference picture list (i.e., the reference picture list 0). In the decoding process of the B picture (or slice), two reference pictures lists (i.e., the reference picture list 0 and the reference picture list 1) may be used. Information for distinguishing between such reference picture lists for each reference picture may be provided to the decoder through reference picture set information. The decoder adds a reference picture to the reference picture list 0 or the reference picture list 1 based on reference picture set information.

In order to identify any one specific reference picture within a reference picture list, a reference picture index (or reference index) is used.

—Fractional Sample Interpolation

A sample of a prediction block for an inter-predicted current processing block is obtained from the sample value of a corresponding reference region within a reference picture identified by a reference picture index. In this case, a corresponding reference region within a reference picture indicates the region of a location indicated by the horizontal component and vertical component of a motion vector. Fractional sample interpolation is used to generate a prediction sample for non-integer sample coordinates except a case where a motion vector has an integer value. For example, a motion vector of ¼ scale of the distance between samples may be supported.

In the case of HEVC, fractional sample interpolation of a luma component applies an 8 tab filter in the traverse direction and longitudinal direction. Furthermore, the fractional sample interpolation of a chroma component applies a 4 tab filter in the traverse direction and the longitudinal direction.

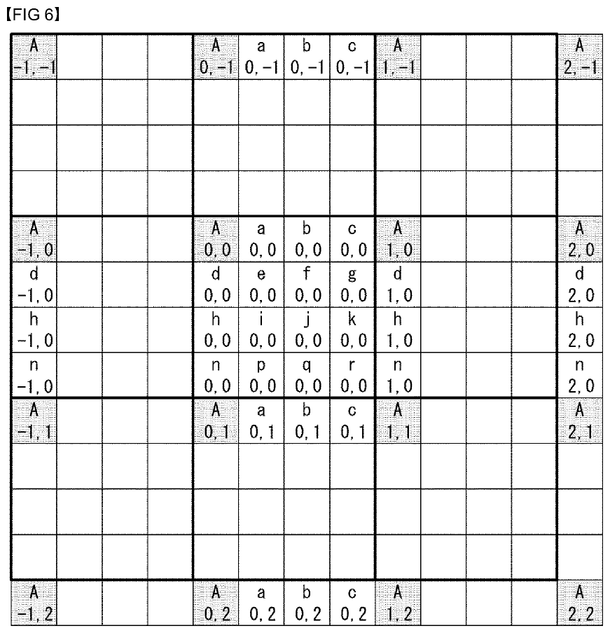

FIG. 6 is an embodiment to which the present invention may be applied and illustrates integers for ¼ sample interpolation and a fraction sample locations.

Referring to FIG. 6, a shadow block in which an upper-case letter (A_i,j) is written indicates an integer sample location, and a block not having a shadow in which a lower-case letter (x_i,j) is written indicates a fraction sample location.

A fraction sample is generated by applying an interpolation filter to an integer sample value in the horizontal direction and the vertical direction. For example, in the case of the horizontal direction, the 8 tab filter may be applied to four integer sample values on the left side and four integer sample values on the right side based on a fraction sample to be generated.

—Inter-Prediction Mode

In HEVC, in order to reduce the amount of motion information, a merge mode and advanced motion vector prediction (AMVP) may be used.

1) Merge Mode

The merge mode means a method of deriving a motion parameter (or information) from a spatially or temporally neighbor block.

In the merge mode, a set of available candidates includes spatially neighboring candidates, temporal candidates and generated candidates.

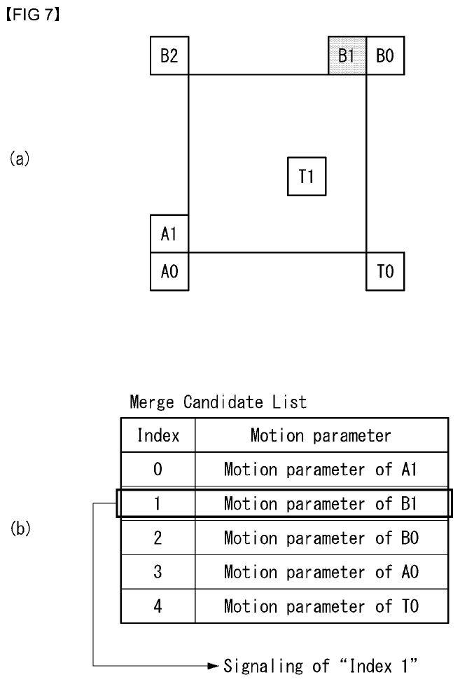

FIG. 7 is an embodiment to which the present invention may be applied and illustrates the location of a spatial candidate.

Referring to FIG. 7(a), whether each spatial candidate block is available depending on the sequence of {A1, B1, B0, A0, B2} is determined. In this case, if a candidate block is not encoded in the intra-prediction mode and motion information is present or if a candidate block is located out of a current picture (or slice), the corresponding candidate block cannot be used.

After the validity of a spatial candidate is determined, a spatial merge candidate may be configured by excluding an unnecessary candidate block from the candidate block of a current processing block. For example, if the candidate block of a current prediction block is a first prediction block within the same coding block, candidate blocks having the same motion information other than a corresponding candidate block may be excluded.

When the spatial merge candidate configuration is completed, a temporal merge candidate configuration process is performed in order of {T0, T1}.

In a temporal candidate configuration, if the right bottom block T0 of a collocated block of a reference picture is available, the corresponding block is configured as a temporal merge candidate. The collocated block means a block present in a location corresponding to a current processing block in a selected reference picture. In contrast, if not, a block T1 located at the center of the collocated block is configured as a temporal merge candidate.

A maximum number of merge candidates may be specified in a slice header. If the number of merge candidates is greater than the maximum number, a spatial candidate and temporal candidate having a smaller number than the maximum number are maintained. If not, the number of additional merge candidates (i.e., combined bi-predictive merging candidates) is generated by combining candidates added so far until the number of candidates becomes the maximum number.

The encoder configures a merge candidate list using the above method, and signals candidate block information, selected in a merge candidate list by performing motion estimation, to the decoder as a merge index (e.g., merge_idx[x0][y0]′). FIG. 7(b) illustrates a case where a B1 block has been selected from the merge candidate list. In this case, an “index 1 (Index 1)” may be signaled to the decoder as a merge index.

The decoder configures a merge candidate list like the encoder, and derives motion information about a current prediction block from motion information of a candidate block corresponding to a merge index from the encoder in the merge candidate list. Furthermore, the decoder generates a prediction block for a current processing block based on the derived motion information (i.e., motion compensation).

2) Advanced Motion Vector Prediction (AMVP) Mode

The AMVP mode means a method of deriving a motion vector prediction value from a neighbor block. Accordingly, a horizontal and vertical motion vector difference (MVD), a reference index and an inter-prediction mode are signaled to the decoder. Horizontal and vertical motion vector values are calculated using the derived motion vector prediction value and a motion vector difference (MVDP) provided by the encoder.

That is, the encoder configures a motion vector predictor candidate list, and signals a motion reference flag (i.e., candidate block information) (e.g., mvp_IX_flag[x0][y0]′), selected in motion vector predictor candidate list by performing motion estimation, to the decoder. The decoder configures a motion vector predictor candidate list like the encoder, and derives the motion vector predictor of a current processing block using motion information of a candidate block indicated by a motion reference flag received from the encoder in the motion vector predictor candidate list. Furthermore, the decoder obtains a motion vector value for the current processing block using the derived motion vector predictor and a motion vector difference transmitted by the encoder. Furthermore, the decoder generates a prediction block for the current processing block based on the derived motion information (i.e., motion compensation).

In the case of the AMVP mode, two spatial motion candidates of the five available candidates in FIG. 7 are selected. The first spatial motion candidate is selected from a {A0, A1} set located on the left side, and the second spatial motion candidate is selected from a {B0, B1, B2} set located at the top. In this case, if the reference index of a neighbor candidate block is not the same as a current prediction block, a motion vector is scaled.

If the number of candidates selected as a result of search for spatial motion candidates is 2, a candidate configuration is terminated. If the number of selected candidates is less than 2, a temporal motion candidate is added.

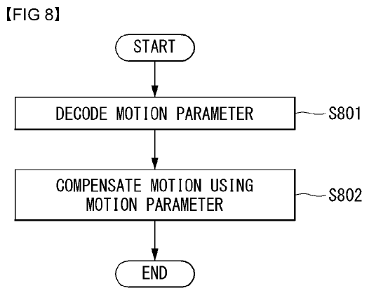

FIG. 8 is an embodiment to which the present invention is applied and is a diagram illustrating an inter-prediction method.

Referring to FIG. 8, the decoder (in particular, the inter-prediction unit 261 of the decoder in FIG. 2) decodes a motion parameter for a processing block (e.g., a prediction unit) (S801).

For example, if the merge mode has been applied to the processing block, the decoder may decode a merge index signaled by the encoder. Furthermore, the motion parameter of the current processing block may be derived from the motion parameter of a candidate block indicated by the merge index.

Furthermore, if the AMVP mode has been applied to the processing block, the decoder may decode a horizontal and vertical motion vector difference (MVD), a reference index and an inter-prediction mode signaled by the encoder. Furthermore, the decoder may derive a motion vector predictor from the motion parameter of a candidate block indicated by a motion reference flag, and may derive the motion vector value of a current processing block using the motion vector predictor and the received motion vector difference.

The decoder performs motion compensation on a prediction unit using the decoded motion parameter (or information) (S802).

That is, the encoder/decoder perform motion compensation in which an image of a current unit is predicted from a previously decoded picture using the decoded motion parameter.

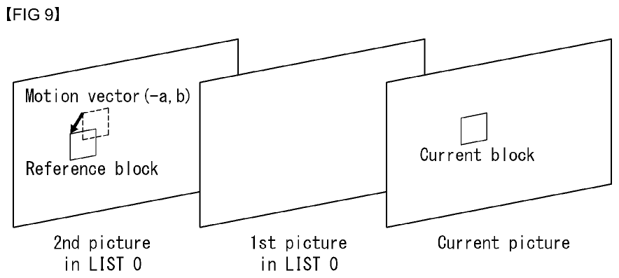

FIG. 9 is an embodiment to which the present invention may be applied and is a diagram illustrating a motion compensation process.

FIG. 9 illustrates a case where a motion parameter for a current block to be encoded in a current picture is uni-direction prediction, a second picture within LIST0, LIST0, and a motion vector (−a, b).

In this case, as in FIG. 9, the current block is predicted using the values (i.e., the sample values of a reference block) of a location (−a, b) spaced apart from the current block in the second picture of LIST0.

In the case of bi-directional prediction, another reference list (e.g., LIST1), a reference index and a motion vector difference are transmitted. The decoder derives two reference blocks and predicts a current block value based on the two reference blocks.

Optical Flow (OF)

An optical flow refers to a motion pattern, such as an object or which surface or an edge in a view. That is, a pattern of a motion for an object is obtained by sequentially extracting differences between images at a specific time and a previous time. In this case, information about more motions can be obtained compared to a case where a difference between a current frame and a previous fame only is obtained. The optical flow has a very important contribution, such as that it enables a target point of a moving object to be obtained in the visual recognition function of an animal having a sense of view and helps to understand the structure of a surrounding environment. Technically, the optical flow may be used to analyze a three-dimensional image in the computer vision system or may be used for image compression. Several methods of realizing the optical flow have been proposed.

In a motion compensation method applying the optical flow, by assuming that pixel values of an object are not changed in consecutive frames (Brightness Constancy Constraint; BCC), a motion of an object may be represented as Equation 1.

I(x,y,t)=I(x+Δx,y+Δy,t+Δt) [Equation 1]

Herein, I(x, y, t) represents a pixel value at coordinate (x, y) on time t. Δ represents variation. That is, Δx represents a variation of x, Δy represents a variation of y, and Δt represents a variation of time t.

Assuming a small motion during a short time, in Equation 1, the right term may be represented as a first order mathematical expression of Taylor series, and may be expanded as represented in Equation 2.

$$I ( x , y , t ) = I ( x , y , t ) + \frac{\partial I}{\partial x} Δ x + \frac{\partial I}{\partial y} Δ y + \frac{\partial I}{\partial t} Δ t \qquad [ Equation 2 ]$$

And, when Equation 2 is divided by the variation Δt of time t, and when V_x=Δx/At, V_y=Δy/At, Equation 2 is arranged as Equation 3.

$$0 = \frac{dI}{dt} = \frac{\partial I}{\partial x} {V}_{x} + \frac{\partial I}{\partial y} {V}_{y} + \frac{\partial I}{\partial t} \qquad [ Equation 3 ]$$

Herein, V_x and V_y mean x axis component and y axis component of the optical flow (or optical flow motion vector) at I(x, y, t), respectively. ∂I/∂x, ∂I/∂y and ∂I/∂t represent partial derivatives in x axis, y axis and z axis at I(x, y, t), respectively, and may be designated as I_x, I_y and I_t, respectively.

When I_x, I_y and I_t are obtained, the optical flow (or optical flow motion vector) V={V_x, V_y} can be obtained.

Equation 3 may be represented as Equation 4 in a matrix form.

$$[ \begin{matrix}{I}_{x} & {I}_{y}\end{matrix} ] [ \begin{matrix}{V}_{x} \\ {V}_{y}\end{matrix} ] = - {I}_{t} \qquad [ Equation 4 ]$$

Assuming that A=[I_x, I_y], V=[V_x, V_y]\hat{ }T and b=−I_t, Equation 4 is as represented in Equation 5.

AV=b [Equation 5]

In order to obtain the optical flow (or optical flow motion vector) V, the Least-square (LS) estimation method is used, generally. First, a square error E, which is an LS estimator, may be designed as represented in Equation 6.

$$E = {\sum }_{ω} g ( ω ) \times {( {I}_{x} {V}_{x} + {I}_{y} {V}_{y} + {I}_{t} )}^{2} \qquad [ Equation 6 ]$$

The LS estimator as represented in Equation 6 may be designed by considering the following two factors.

1) In order to solve the III-posed problem, a locally steady motion is assumed. That is, it is assumed that the optical flows corresponding to a pixel value included in an arbitrary window w area are similar with each other.

2) Weighting function g is considered, in which a small weight value is provided to a pixel value located far from a window center value and a great weight value is provided to a pixel value located near to the window center value.

When Equation 6 is arranged such that a partial derivative value for V_x and V_y is 0, in order to obtain the optical flow V that maximizes the square error E, Equation 6 is arranged as represented in Equation 7.

$$\frac{\partial E}{\partial {V}_{x}} = {\sum }_{ω} g ( ω ) \times ( {V}_{x} {I}_{x}^{2} + {V}_{y} {I}_{x} {I}_{y} + {I}_{x} {I}_{t} ) = 0 \\ \frac{\partial E}{\partial {V}_{y}} = {\sum }_{ω} g ( ω ) \times ( {V}_{y} {I}_{y}^{2} + {V}_{x} {I}_{x} {I}_{y} + {I}_{y} {I}_{t} ) = 0 \qquad [ Equation 7 ]$$

Matrix M, b is defined as Equation 8 as below.

$$M = [ \begin{matrix}{\sum }_{ω} {gI}_{x}^{2} & {\sum }_{ω} {gI}_{x} {I}_{y} \\ {\sum }_{ω} {gI}_{x} {I}_{y} & {\sum }_{ω} {gI}_{y}^{2}\end{matrix} ] \\ b = - [ \begin{matrix}{\sum }_{ω} {gI}_{x} {I}_{t} \\ {\sum }_{ω} {gI}_{y} {I}_{t}\end{matrix} ] \qquad [ Equation 8 ]$$

Equation 7 is arranged as represented in Equation 9 by using Equation 8.

MV=b [Equation 9]

Accordingly, the optical flow V by the LS estimator is determined as Equation 10.

V=M⁻¹b [Equation 10]

BIO is a method of obtaining a motion vector and a reference sample (or prediction sample) value in a unit of sample (pixel) without transmitting an additional motion vector (MV) by using the optical flow.

Further to the first assumption (when an object moves during a short time, the pixel value is not changed) of the optical flow, described above, it is assumed that an object moves in a uniform velocity during a short time.

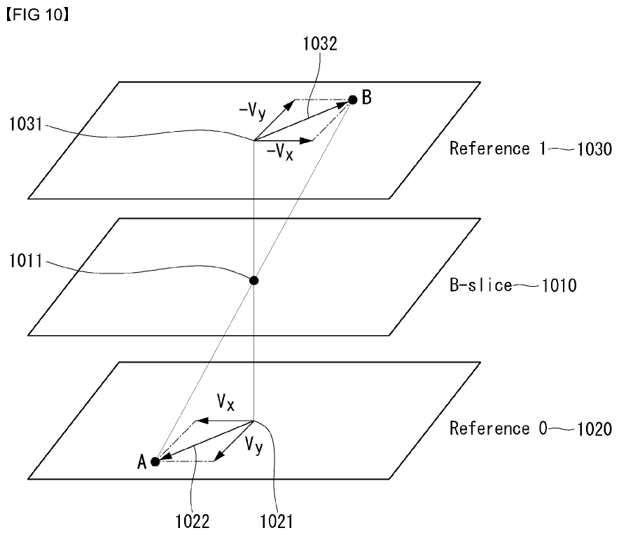

FIG. 10 illustrates a bi-directional prediction method of a picture having a steady motion as an embodiment to which the present invention may be applied.

Referring to FIG. 10, it is shown the case that bi-directional reference pictures (Refs) 1020 and 1030 are existed with a current picture (or B-slice) 1010 as the center.

At this time, as described above, by the assumption that an object has a steady motion, when the bi-directional reference pictures 1020 and 1030 are existed with the current picture 1010 as the center, a motion vector (hereinafter, referred to as ‘a first motion vector’) 1022 reaching position A from a corresponding pixel (hereinafter, referred to as ‘a first corresponding pixel’) in a reference picture 0 (1020), which corresponds to a current pixel 1011 in the current picture 1010 (i.e., coordinate is collated with the current pixel 1011) and a motion vector (hereinafter, referred to as ‘a second motion vector’) 1032 reaching position B from a corresponding pixel (hereinafter, referred to as ‘a second corresponding pixel’) in a reference picture 1 (1030), which corresponds to a current pixel 1011 (i.e., coordinate is collated with the current pixel 1011) may be represented as a symmetric value.

That is, the motion vector 1022 and the motion vector 1032 may be represented as vectors of which sizes are the same and of which directions are opposite.

By the two assumptions described above, a difference of pixel values in position A and position B is arranged as represented in Equation 11.

∇[i,j]=I⁰[i+vₓ,j+v_{y}]−I¹[i−vₓ,j−v_{y}] [Equation 11]

Herein, I\hat{ }0[i+v_x, j+v_y] is a pixel value in position A of the reference picture 0 (Ref0) 1020, and I\hat{ }1[i−v_x, j−v_y] is a pixel value in position B of the reference picture 1 (Ref1) 1030. In addition, (i, j) means a coordinate of the current pixel 1011 in the current picture 1010.

Each pixel value may be represented as Equation 12.

$${I}^{0} [ i + {v}_{x} , j + {v}_{y} ] = {I}^{0} [ i , j ] + \frac{\partial {I}^{0} [ i , j ]}{\partial x} {v}_{x} + \frac{\partial {I}^{0} [ i , j ]}{\partial y} {v}_{y} \\ {I}^{1} [ i - {v}_{x} , j - {v}_{y} ] = {I}^{1} [ i , j ] - \frac{\partial {I}^{1} [ i , j ]}{\partial x} {v}_{x} - \frac{\partial {I}^{1} [ i , j ]}{\partial y} {v}_{y} \qquad [ Equation 12 ]$$

When Equation 11 is substituted by Equation 12, Equation 11 may be arranged as Equation 13.

∇[i,j]=I⁽⁰⁾[i,j]−I⁽¹⁾[i,j]+vₓ[i,j](Iₓ⁽⁰⁾[i,j]+Iₓ⁽¹⁾[i,j])+v_{y}[i,j](I_{y}⁽⁰⁾[i,j]+I_{y}⁽¹⁾[i,j]) [Equation 13]

I_x\hat{ }(0)[i, j] and I_y\hat{ }(0)[i, j] are partial derivative values in x axis and y axis at the first corresponding pixel position in the reference picture 0 (Ref0) 1020, and I_x\hat{ }(1)[i, j] and I_y\hat{ }(1)[i, j] are partial derivative values in x axis and y axis at the second corresponding pixel position in the reference picture 1 (Ref1) 1030, which mean gradients (or variations) of the corresponding pixels at position [i, j].

Table 1 represents interpolation filter coefficients which may be used for calculating BIO gradient (or variation).

TABLE 1

| Fractional pel position | Interpolation filter for gradient |
|---|---|
| 0 | {8, −39, −3, 46, −17, 5}, |
| ¼ | {4, −17, −36, 60, −15, 4}, |
| 2/4 | {−1, 4, −57, 57, −4, 1}, |
| ¾ | {−4, 15, −60, 36, 17, −4} |

By using Equation 14 below and the interpolation filter represented in Table 1, the BIO gradient may be determined.

$${I}_{x}^{( k )} [ i , j ] = {\sum }_{n = - M + 1}^{M} {dF}_{n} ( {α}_{x}^{( k )} ) {R}^{( k )} [ i + n , j ] , k = 0 or 1 \\ {I}_{y}^{( k )} [ i , j ] = {\sum }_{n = - M + 1}^{M} {dF}_{n} ( {α}_{y}^{( k )} ) {R}^{( k )} [ i , j + n ] , k = 0 or 1 \qquad [ Equation 14 ]$$

Herein, 2*M means the number of filter tabs. α_x\hat{ }(k) means a fractional part of the motion vector and dF_n(α_x\hat{ }(k)) means a coefficient of n^{th} filter tap at α_x\hat{ }(k). R\hat{ }(k)[i+n, j] means a reconstructed pixel value at coordinate [i+n, j] in the reference picture k (k is 0 or 1).

Since it is assumed that when an object moves during a short time, the pixel value is not changed, by Equation 13, the motion vectors V_x[i, j] and V_y[i, j] of a unit of pixel, which minimize Δ²(i, j) can be found.

Consequently, although it is an object to find the motion vector in which the pixel value in position A in the reference picture 0 (1020) and the pixel value in position B in the reference picture 1 (1030) have the same value (or of which difference is the minimum), since an error between pixels may be great, within a predetermined window size, a motion vector in which a difference of pixels is the minimum may be found.

Accordingly, by assuming that there is locally steady motion within window Ω with coordinate [i, j] of the current pixel 1011 at the center, the position of pixel in the window of (2M+1)×(2M+1) size may be represented as [i′, j′]. At this time, [i′, j′] satisfies the condition, i−M≤i′≤i+M, j−M≤j′≤j+M.

Accordingly, the motion vector that minimizes ΣΩ[Δ²(i′, j′)] is found.

Gx=(Iₓ⁽⁰⁾[i′,j′]+Iₓ⁽¹⁾[i′,j′])

Gy=(I_{y}⁽⁰⁾[i′,j′]+I_{y}⁽¹⁾[i′,j′])

δP=(P⁽⁰⁾[i′,j′]−P⁽¹⁾[i′,j′]) [Equation 15]

G_x represents a gradient in x axis (i.e., horizontal direction), G_y x represents a gradient in y axis (i.e., vertical direction), and δP represents a gradient in t axis (or variation of a pixel value according to time).

Considering the locally steady motion, when each term of Equation 13 is substituted by Equation 15, Equation 13 is represented as Equation 16.

$${\sum }_{Ω} {Δ}^{2} ( {i}^{′} , {j}^{′} ) = {( Vx {\sum }_{Ω} Gx + Vy {\sum }_{Ω} Gy + {\sum }_{Ω} δ P )}^{2} \qquad [ Equation 16 ]$$

When Equation 16 is partially differentiated by V_x and V_y, respectively, Equation 16 is represented as Equation 17, respectively.

VxΣ_{Ω}G²x+VyΣ_{Ω}GxGy+Σ_{Ω}GxδP=0

VxΣ_{Ω}GxGy+VyΣ_{Ω}G²y+Σ_{Ω}GyδP=0 [Equation 17]

And, for calculating V_x and V_y, S1 to S6 may be defined as represented in Equation 18.

s1=Σ_{Ω}G²x

s2=s4=Σ_{Ω}GxGy

s3=−Σ_{Ω}GxδP

s5=Σ_{Ω}G²y

s6=−Σ_{Ω}GyδP [Equation 18]

By using Equation 18, V_x and V_y of Equation 17 is arranged as represented in Equation 19, respectively.

$$Vx = \frac{s 3 s 5 - s 2 s 6}{s 1 s 5 - s 2 s 4} \\ Vy = \frac{s 1 s 6 - s 3 s 4}{s 1 s 5 - s 2 s 4} \qquad [ Equation 19 ]$$

Accordingly, a predictor of the current pixel can be calculated as represented in Equation 20 by using V_x and V_y.

$$[ Equation 20 ]$$

$$P = \frac{( ( {P}^{( 0 )} + {P}^{( 1 )} ) + {V}_{x} ( {I}_{x}^{( 0 )} - {I}_{x}^{( 1 )} ) + {V}_{y} ( {I}_{y}^{( 0 )} - {I}_{y}^{( 1 )} ) )}{2}$$

Herein, P represents a predictor for the current pixel in the current block. P\hat{ }(0) and P\hat{ }(1) represent each pixel value of the pixels in which the coordinates are collated with the current pixel in the reference block L0 and reference block L1, respectively (i.e., the first corresponding pixel and the second corresponding pixel).

In the case that a motion vector of a unit of pixel is calculated by using Equation 19 in an encoder/decoder, much amount of calculation may be required. Accordingly, in order to reduce calculation complexity, Equation 19 may be approximated and used as represented in Equation 21.

$$Vx = \frac{s 3}{s 1} \\ Vy = \frac{s 6 - Vx * s 2}{s 5} \qquad [ Equation 21 ]$$

The BIO method, that is, the Optical flow motion vector refinement method may be performed in the motion compensation procedure in the case that the bi-directional prediction is applied to the current block. The detailed method is described with reference to the following drawing.

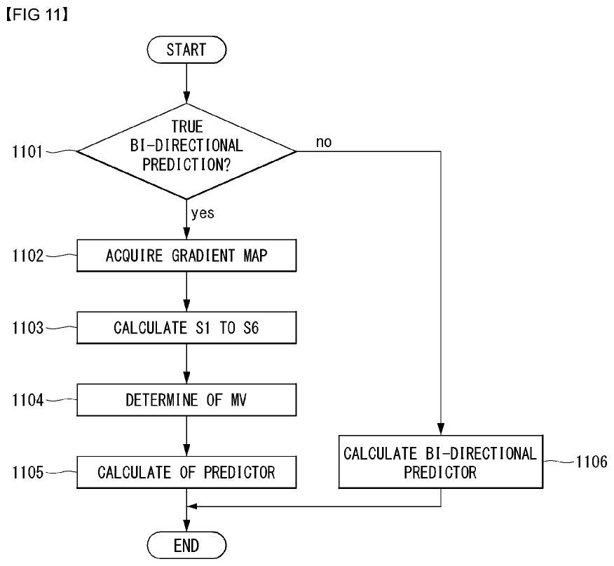

FIG. 11 is a diagram illustrating a motion compensation method through the bi-directional prediction according to an embodiment of the present invention.

An encoder/decoder determines whether the True bi-directional prediction is applied to a current block (step, S1101).

That is, the encoder/decoder determines whether the bi-prediction is applied to the current block and the reference picture 0 (Ref0) and the reference picture 1 (Ref1) are opposite on time axis based on the current block (or current picture) (i.e., Picture Order Count (POC) of the current picture is located between POCs of two reference pictures).

As a result of the determination in step S1101, in the case that the True bi-directional prediction is applied to a current block, the encoder/decoder obtains a gradient map of the current block (step, S1102).

When a width and a height of the current block (PU, in the example of HEVC) are denoted by w and h, respectively, the encoder/decoder may obtain the gradient for each of x axis and y axis of each corresponding pixel of (w+4)×(h+4) size, and determine it as the gradient map of x axis and y axis, respectively.

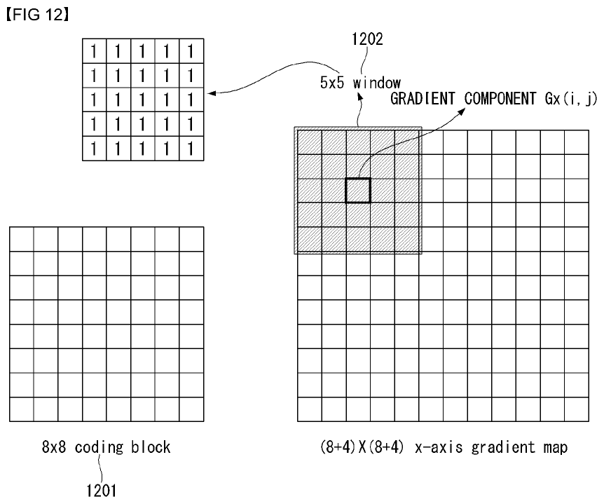

FIG. 12 is a diagram illustrating a method for determining a gradient map according to an embodiment of the present invention.

Referring to FIG. 12, it is assumed the case that a size of a current block 1201 is 8×8. In the case that a window 1202 of 5×5 size is applied to the current block 1201, a gradient map of 12×12 size may be determined.

Referring to FIG. 11 again, the encoder/decoder calculates S1 to S6 values by using the window (1201 in FIG. 12) of 5×5 size (step, S1103).

The S1 to S6 values may be calculated by using Equation 18 described above.

The encoder/decoder determines an OF motion vector of the current pixel (step, S1104).

The method of determining the OF motion vector is described below.

The encoder/decoder calculates an OF predictor, and determines the calculated OF predictor as an optimal predictor (step, S1105).

In other words, the encoder/decoder may calculate a prediction value for the current pixel as represented in Equation 20 by using the OF motion vector (or motion vector of a unit of pixel) which is determined in step S1104, and determine the predictor for the calculated current pixel as an optimal predictor (or final predictor of the current pixel).

As a result of the determination in step S1101, in the case that the True bi-directional prediction is not applied to the current block, the encoder/decoder calculates the bi-directional predictor by performing bi-directional prediction, and determines the calculated bi-directional predictor as an optimal predictor (step, S1106).

That is, in the case that the True bi-directional prediction is not applied to the current block, the motion compensation of a unit of pixel based on the optical flow may not be performed.

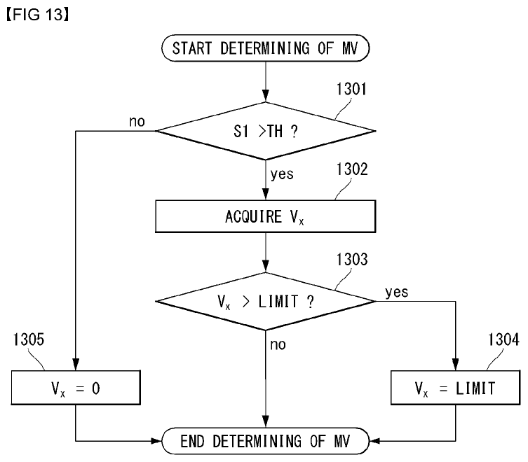

FIG. 13 is a diagram illustrating a method of determining an optical flow motion vector according to an embodiment of the present invention.

In FIG. 13, it is described a method of determining a horizontal directional component (i.e., x axis directional component) of an optical flow motion vector (or motion vector of a unit of pixel).

An encoder/decoder determines whether S1 value is greater than a specific threshold value (step, S1301).

As a result of the determination of step S1301, in the case that S1 value is greater than a threshold value, the encoder/decoder obtains V_x value (step, S1302).

At this time, the encoder/decoder may calculate the V_x value by using Equation 19 or Equation 21.

The encoder/decoder determines whether the V_x value obtained in step S1302 is greater than a limit value (step, S1303).

As a result of the determination of step S1303, in the case that the V_x value is greater than the limit value, the encoder/decoder set the V_x value as the limit value (step, S1304).

As a result of the determination of step S1303, in the case that the V_x value is not greater than the limit value, the value which is calculated in step S1302 is determined as the V_x value.

As a result of the determination of step S1301, in the case that S1 value is not greater than a threshold value, the encoder/decoder set the V_x value as 0 (step, S1306).

The encoder/decoder may determine the optical flow motion vector of y axis direction (i.e., horizontal directional component of the optical flow motion vector (or motion vector in a unit of pixel)) in a method similar to the method described in FIG. 13.

First, the encoder/decoder determines whether S5 value is greater than a specific threshold value, and in the case that S5 value is greater than a threshold value, the encoder/decoder calculates the V_y value by using Equation 19 or Equation 21. In addition, the encoder/decoder determines the calculated V_y value is greater than a limit value, and in the case that the V_y value is greater than the limit value, the encoder/decoder set the V_y value as the limit value. In the case that the V_y value is not greater than the limit value, the V_y value is determined as the calculated value. Further, in the case that S5 value is not greater than a threshold value, the encoder/decoder set the V_y value as 0.

After determining the V_x and the V_y, the encoder/decoder may calculate the OF predictor to which the OF motion vector refinement is applied in a unit of pixel by using Equation 20.

Inter Prediction Based Image Processing Method

As described above, an LS estimator may be designed by considering 1) the pixel values contained in any window w area and 2) a weighting function g to assign a small weight to pixel values located far away from a median value of the window and assign a large weight to pixel values located close to the mean value of the window.

However, the existing Bi-directional Optical Flow (BIO) method 1) uses fixed size 5×5 window and 2) assigns the same weight to gradients included in the window area.

Accordingly, in order to enhance the accuracy of the pixel-unit motion prediction, a method for adaptively adjusting the size of the window and 2) a method for designing the weighting function to assign a smaller weight as a distance from a center pixel of the window.

Hereinafter, in describing the present invention, a motion vector (i.e., V_x, V_y of Equations 19 to 21 above) derived for the pixe-unit motion compensation (i.e., BIO) may be referred to as an optical flow, an optical flow motion vector, a pixel-unit motion vector, a displacement vector, etc.

### Embodiment 1

The embodiment proposes a method for improving the existing BIO method using the fixed size window.

Specifically, the embodiment proposes a method using a window from which outliers having different characteristics are removed in the window area.

Here, the outlier represents a pixel (or gradient component) having gradients with different motions or different features, that is, a pixel (or gradient component) that may violate a locally steady motion assumption.

In addition, the gradient may represent a horizontal or vertical partial differential value in the window area, the gradient may be calculated by using an increase/decrease rate (or a slope) of a plurality of horizontal or vertical pixels in the window area or calculated by using a predetermined interpolation filter (e.g., see Table 1 and Equation 14 above).

Hereinafter, for convenience of description, it is assumed that the window size is 5×5 in the description of the embodiment, but the present invention is not limited thereto. That is, the pixel-unit motion compensation may be performed by using a window from which the outlier is removed from a window with a size other than the 5×5 size of window.

With reference to the following drawings, a method for performing the pixel-unit motion compensation by excluding the outlier from the 5×5 size of window and using the window without the outlier.

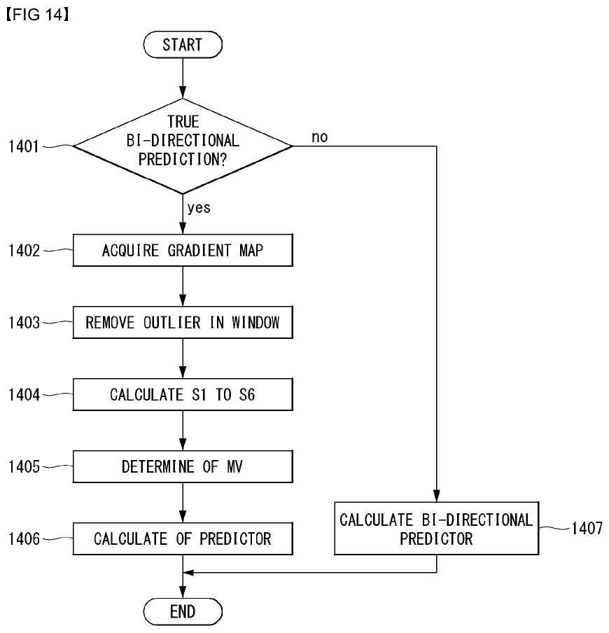

FIG. 14 is a diagram illustrating a method for compensating a motion through bi-directional prediction according to an embodiment of the present invention.

An encoder/decoder determines whether true bi-prediction is applied to a current block (S1401).

That is, the encoder/decoder determines whether the bi-prediction is applied to the current block and reference picture 0 Ref0 and reference picture 1 Ref1 are opposite on a time axis with respect to the current block (or the current picture) (that is, when a Picture Order Count (POC) of the current picture is between the POCs of the two reference pictures).

As a result of determination in step S1401, when the true bi-prediction is applied to the current block, the encoder/decoder obtains a gradient map of the current block (S1402).

When the width and height of the current block (HEVC, for example, PU) are w and h, respectively, the encoder/the decoder may obtain each of gradients for an x axis and a y axis of each corresponding pixel in a block having a size of (w+4)×(h+4) and determine the obtained gradient as the gradient map for each of the x axis and the y axis.

The encoder/decoder removes the outlier from the gradient components included in the window area having the 5×5 size.

That is, the encoder/decoder determines whether the gradient component of each pixel of the window area having the 5×5 size corresponds the outlier and removes (or excludes) the gradient component corresponding the outlier. A method for determining whether the gradient component corresponds to the outlier.

In this case, the window area may correspond to a window area centered on a pixel which has the same coordinate as (is collocated with) each pixel of the current block in a first reference block in a first reference picture of the current block specified by the motion vector of the current block and a second reference block in a second reference picture specified by the motion vector of the current block.

The encoder/decoder calculates S to S6 values using the window in which the outlier is removed in step S1403 (S1404).

In this case, S1 to S6 may be calculated using Equation 22 below.

$$s 1 = {\sum }_{{Ω}^{′}} {Gx}^{2} \\ s 2 = s 4 = {\sum }_{{Ω}^{′}} GxGy \\ s 3 = - {\sum }_{{Ω}^{′}} Gx δ P \\ s 5 = {\sum }_{{Ω}^{′}} {Gy}^{2} \\ s 6 = - {\sum }_{{Ω}^{′}} Gy δ P \qquad [ Equation 22 ]$$

Here, Ω′ represents the window area of 5×5 size from which the outlier is excluded. That is, S1 to S6 may be calculated using the gradient component in the window area from which the outlier is excluded.

The encoder/decoder determines the optical flow (OF) motion vector of the current pixel (S1405).

Here, the optical flow motion vector may be determined by the method described in FIG. 13 above.

The encoder/decoder calculates an optical flow (OF) predictor and determines an optimal predictor of the calculated optical flow predictor (S1406).

In other words, the encoder/decoder may calculate a predictor for the current pixel as shown in Equation 20 by using the optical flow motion vector (or pixel-unit motion vector) determined in step S1405 and determine the calculated predictor for the current pixel as the optimal predictor.

As the result of the determination in step S1401, when the true bi-prediction is not applied to the current block, the encoder/decoder calculates the bi-directional predictor by performing the bi-directional prediction and determines the calculated bi-directional predictor (S1407).

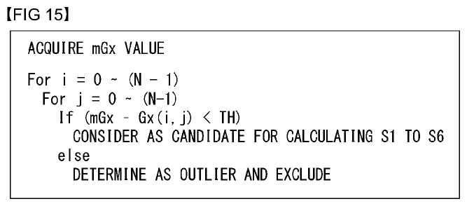

FIG. 15 is a diagram for describing a method for removing an outlier in a window area as an embodiment to which the present invention may be applied.

Referring to FIG. 15, the method is described by assuming that the window has an N×N size. In addition, whether the gradient component corresponds to the outlier may be independently determined for each of an x-axis direction and a y-axis direction and in FIG. 15, a method for determining whether the gradient component corresponds to the outlier based on the x-axis direction.

—The encoder/decoder acquires an mG_x value.

Here, mG_x as a representative value (or reference value) of a horizontal gradient in the window and for example, mG_x may be determined as the following values.

1. Mean value of horizontal gradient in window

2. Median value of horizontal gradient in window

3. Horizontal gradient value in central pixel in window

That is, mG_x may be determined as the mean value of the horizontal gradient components of the pixels in the window area, the median value of the horizontal gradient component of the pixels in the window area, or the horizontal gradient component of the pixel positioned at the center of the window. However, this is just an example and the present invention is not limited thereto.

The encoder/decoder determines whether each of difference values between the acquired mG_x and the gradients of all pixels in the window area is smaller than a specific threshold.

When the difference value between the mG_x and the gradient of the current pixel is smaller than the specific threshold, the encoder/decoder considers the gradient of the current pixel as a candidate at the time of calculating S1 to S6 using Equation 22 described above.

That is, the encoder/decoder may calculate S1 to S6 through Equation 22 by encapsulating the gradient of the current pixel in the window area.

When the difference value of the mG_x and the gradient of the current pixel is not smaller than the specific threshold, the encoder/decoder determines the gradient of the current pixel as the outlier and excludes the outlier from the window area.

The encoder/decoder may determine whether the gradient component corresponds to the outlier based on the y-axis direction similarly to the method described in FIG. 15. That is, the encoder/decoder acquires mG_y as a representative value (or reference value) of the vertical gradient in the window.

In this case, mG_y may be determined as the mean value of the vertical gradient components of the pixels in the window area, the median value of the vertical gradient component of the pixels in the window area, or the vertical gradient component of the pixel positioned at the center of the window. However, this is just an example and the present invention is not limited thereto.

In addition, the encoder/decoder determines whether each of difference values between the acquired mG_y and the gradients of all pixels in the window area is smaller than a specific threshold. According to the determination result, when the difference value between the mG_y and the gradient of the current pixel is smaller than the specific threshold, the encoder/decoder considers the gradient of the current pixel as a candidate at the time of calculating S1 to S6 using Equation 22 described above. When the difference value of the mG_y and the gradient of the current pixel is not smaller than the specific threshold, the encoder/decoder determines the gradient of the current pixel as the outlier and excludes the outlier from the window area.

The encoder/decoder may calculate S1 to S6 by removing the outlier in units of the window and using the window area from which the outlier is removed. In this case, a window unit outlier removing method that may be used to reduce computational complexity will be described with reference to the following drawings.

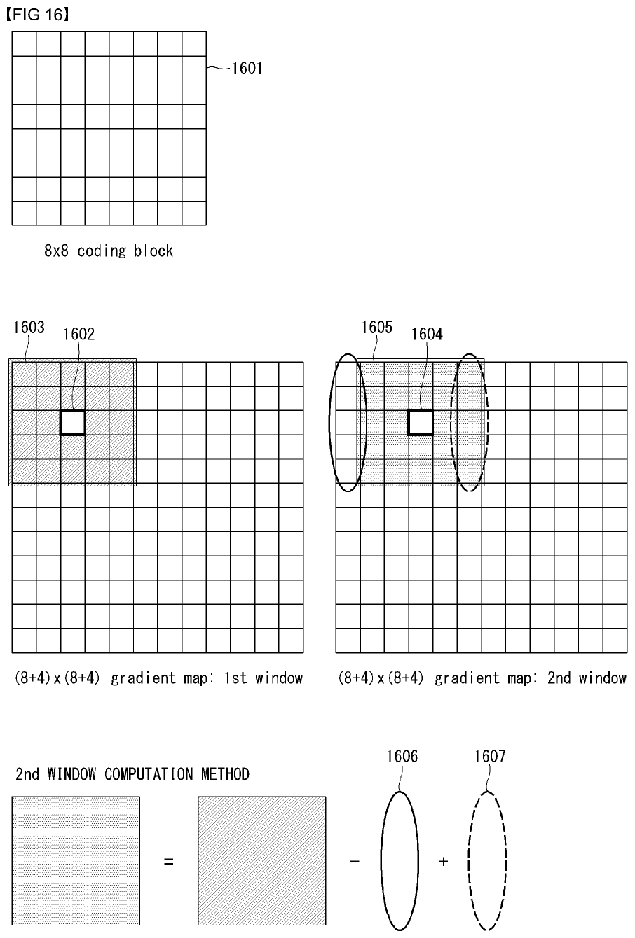

FIG. 16 is a diagram for describing a method for removing an outlier in a window area as an embodiment to which the present invention may be applied.

Referring to FIG. 16, it is assumed that the size of a current block 1601 is 8×8. When the window having the 5×5 size is applied to the current block 1601 having 8×8 size, a gradient map having a 12×12 size may be determined.

The encoder/decoder determines whether the gradients of the pixels in a window area 1603 centered on a current pixel 1602 corresponds to the outlier and performs pixel-unit motion compensation using the gradient in the window area from which the outlier is removed.

In addition, the encoder/decoder determines whether the gradients of the pixels in a window area 1605 centered on a next pixel 1604 of the current pixel 1602 corresponds to the outlier.

In this case, the encoder/decoder may not determine whether each of the gradients of 25 pixels in the window area 1605 centered on the next pixel 1604 of the current pixel 1602 correspond to the outlier, but determine whether the gradient only for each of 5 right pixels 1607 newly added corresponds to the outlier.

In other words, apart duplicated with the window area 1603 centered on the current pixel 1602 is excluded from the window area 1605 centered on the next pixel 1604 of the current pixel 1602 to determine whether the gradient for the remaining part corresponds to the outlier.

That is, the encoder/decoder determines whether only a gradient 1607 for each of 5 right pixels added in the current window area 1605 by excluding a gradient 1606 for each of 5 left pixels from the previous window area 1603 corresponds to the outlier to reduce a computation process for determining whether the gradient corresponds to the outlier and reduce the computational complexity in the encoder/decoder.

### Embodiment 2

The embodiment proposes a method for adaptively determining the size of the window according to the size of the current block (e.g., a coding block, a prediction block, etc.).

In the embodiment, the window may have a size of (2N+1)×(2N+1) and in this case, N=0, 1, 2, 3, . . . , N_max. Accordingly, a window Ω_N is defined as a window having the (2N+1)×(2N+1) size.

That is, the encoder/decoder may optionally use the size of the window according to the size of the current block among windows having sizes of 7×7, 5×5, and 3×3 (or windows having sizes other therethan), for example.

Therefore, when a window Ω_N having an adaptive size other than a 5×5 window Ω having a fixed size is considered, S1 to S6 for calculating the optical flow motion vector (i.e., pixel-unit motion vector) may be defined as shown in Equation 23.

$$s 1 = {\sum }_{{Ω}_{N}} {Gx}^{2} \\ s 2 = s 4 = {\sum }_{{Ω}_{N}} Gx * Gy \\ s 3 = - {\sum }_{{Ω}_{N}} Gx * δ P \\ s 5 = {\sum }_{{Ω}_{N}} {Gy}^{2} \\ s 6 = - {\sum }_{{Ω}_{N}} Gy δ P \qquad [ Equation 23 ]$$

Therefore, the encoder/decoder may calculate the optical flow motion vector (or the pixel-unit motion vector) using Equation 19 or 21 described above based on S1 to S6 calculated through Equation 23. In addition, the encoder/decoder may determine a predictor for each pixel by using Equation 20 based on the calculated optical flow motion vector.

In general, considering coding efficiency, a region including a detailed texture or a complex motion is encoded to a block having a small size and a region including a homogeneous texture or a constant motion is encoded to a block having a large size.

Accordingly, in the case of a block which is encoded/decoded to a block having a relatively smaller size, since a probability that a predetermined window will include various motions, pixel-unit motion prediction/compensation is performed by using a window having a relatively smaller size, thereby enhancing accuracy of prediction.

On the contrary, in the case of a block which is encoded to the block having the relatively larger size, the pixel-unit motion prediction/compensation is performed using the window having the relatively larger window, thereby enhancing the accuracy of the prediction.

The accuracy of the prediction may be increased and the encoding efficiency may be enhanced by adaptively selecting and using the size of the window according to the size of the current block (e.g., the coding block, the prediction block, etc.).

For example, the encoder/decoder may use a window having a predefined size according to the size of the current block (e.g., the coding block, the prediction block, etc.).

In the HEVC, the size of the CU may be determined as any one of 64×64, 32×32, 16×16, and 8×8. When the case of the HEVC is described as an example, the window size according to the size of the CU may be defined like an example of Table 2. However, this is one example and the size of the window may be mapped according to the size of the CU by various combinations.

TABLE 2

| Coding unit size | Window size |
|---|---|
| 8 × 8 | 3 × 3 |
| 16 × 16 | 5 × 5 |
| 32 × 32 | 5 × 5 |
| 64 × 64 | 7 × 7 |

On the contrary, the size of the coding block may be determined as any one of 256×256, 128×128, 64×64, 32×32, 16×16, 8×8, and 4×4, for example. In this case, the window size according to the size of the coding block may be determined like an example of Table 3. However, this is one example and the size of the window may be mapped according to the size of the coding block by various combinations.

TABLE 3

| Coding block size | Window size |
|---|---|
| 4 × 4 | 3 × 3 |
| 8 × 8 | 3 × 3 |
| 16 × 16 | 5 × 5 |
| 32 × 32 | 5 × 5 |
| 64 × 64 | 5 × 5 |
| 128 × 128 | 7 × 7 |
| 256 × 256 | 7 × 7 |

Accordingly, the encoder/decoder may perform the pixel-unit motion compensation by determining the size of the window according to the size of the coding unit or the coding block and using the gradient component in the determined window area like examples of Tables 2 and 3.

### Embodiment 3

The embodiment proposes a method for adaptively determining the size of the window according to the form (or a structure and a shape) of the current block (e.g., the coding block, the prediction block, etc.).

In the embodiment, the window may have a size of (2N+1)×(2M+1) and in this case, N_0, 1, 2, 3, . . . , N_max, M=0, 1, 2, 3, . . . , M_max. Accordingly, a window Ω_partType is defined as a window having the (2N+1)×(2M+1) size.

That is, the encoder/decoder may adaptively use even a window having a non-square size as well as a window having a square shape according to the form of the current block.

The coding/decoding block may be partitioned into a square block or a non-square block by considering the coding efficiency according to the characteristics of the image. In this case, the window having the square size or the window having the non-square size is adaptively used according to the form of the coding/decoding block to effectively reflect the motion in the image and enhance the accuracy of the prediction as compared with the existing BIO method.

Therefore, when a window Ω_partType having an adaptive size other than the 5×5 window Ω having the fixed size is considered, S1 to S6 for calculating the optical flow motion vector (i.e., pixel-unit motion vector) may be defined as shown in Equation 24.

$$s 1 = {\sum }_{{Ω}_{partType}} {Gx}^{2} \\ s 2 = s 4 = {\sum }_{{Ω}_{partType}} Gx * Gy \\ s 3 = - {\sum }_{{Ω}_{partType}} Gx * δ P \\ s 5 = {\sum }_{{Ω}_{partType}} {Gy}^{2} \\ s 6 = - {\sum }_{{Ω}_{partType}} Gy δ P \qquad [ Equation 24 ]$$

The encoder/decoder may calculate the optical flow motion vector (or the pixel-unit motion vector) using Equation 19 or 21 described above based on S1 to S6 calculated through Equation 24. In addition, the encoder/decoder may determine a predictor for each pixel by using Equation 20 based on the calculated optical flow motion vector.

A method for selecting the size of the window according to the form of the current block will be described with the HEVC as an example. As described in FIG. 4 above, when it is assumed that the size of one CU is 2N×2N (N=4, 8, 16, 32), one CU may be partitioned into 8 PU types (i.e., 2N×2N, N×N, 2N×N, N×2N, nL×2N, nR×2N, 2N×nU, 2N×nD). In this case, the window size according to the shape of the PU may be determined like an example of Table 4. However, this is an example and the size of the window may be mapped according to the shape of the PU by various combinations and may have a size (or form) other than the window size illustrated in Table 4.

TABLE 4

| Form of PU | Window size |
|---|---|
| 2N × 2N | 5 × 5 |
| 2N × N | 5 × 3 |
| N × 2N | 3 × 5 |
| N × N | 5 × 5 |
| 2N × nU | 5 × 3 |
| 2N × nD | 5 × 3 |
| nL × 2N | 3 × 5 |
| nR × 2N | 3 × 5 |

Accordingly, the encoder/decoder may perform the pixel-unit motion compensation by determining the size of the window according to the size of the PU and using the gradient component in the determined window area like the example of Table 4.

### Embodiment 4

In the existing BIO method, the same weight is granted to the gradient included in the window area. That is, in the existing BIO method, the same weight is applied to all coefficients (i.e., gradient components) in the window (1202 of FIG. 12 above).

On the contrary, the embodiment proposes a method for granting the weight according to the distance from the median value of the window.

Specifically, the embodiment proposes a pixel-unit motion compensating method considering the weighting function to grant a small weight to a pixel value positioned far away from the median value of the window and grant a large weight to a pixel value positioned closer to the median value.

Here, the median value means a gradient component positioned at the center of the window having the (2N+1)×(2N+1) size.

Considering a weighting function g applied to the window area, Equation 18 described above may be expressed as shown in Equation 25.

$$s 1 = {\sum }_{Ω} g ( Ω ) * {Gx}^{2} \\ s 2 = s 4 = {\sum }_{Ω} g ( Ω ) * Gx * Gy \\ s 3 = - {\sum }_{Ω} g ( Ω ) * Gx * δ P \\ s 5 = {\sum }_{Ω} g ( Ω ) * {Gy}^{2} \\ s 6 = - {\sum }_{Ω} g ( Ω ) * Gy δ P \qquad [ Equation 25 ]$$

The encoder/decoder may calculate the optical flow motion vector (or the pixel-unit motion vector) using Equation 19 or 21 described above based on S1 to S6 calculated through Equation 25. In addition, the encoder/decoder may determine a predictor for each pixel by using Equation 20 based on the calculated optical flow motion vector.

A window in which the distance from the median value of the square window area increases, a smaller weight is granted will be described with reference to the following drawing.

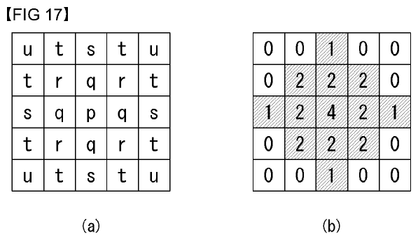

FIG. 17 is a diagram illustrating a method for applying a weight in a window area as an embodiment to which the present invention may be applied.

Referring to FIG. 17, the method will be described by assuming the case where the window having the 5×5 size is used. However, the present invention is not limited thereto and the weight depending on the distance from the median value in the window area may be granted even to the window (e.g., windows having sizes of 9×9, 7×7, and 3×3) using the same method.

Referring to FIG. 17(a), a weight p may be applied to a median value in the window having the 5×5 size and weights of q, r, s, t, and u may be sequentially applied according to the distance from the median value. Here, q, r, s, t, and u may be determined as predetermined values.

Referring FIG. 17(b), an example of a method for granting the weight in the window area is illustrated. That is, a weight 4 may be applied to the median value of the window, a weight 2 may be applied to 8 coefficients adjacent to the median value, a weight 1 may be applied to 4 coefficients in which a vertical distance from the median value is 2, and a weight 0 may be applied to the remaining coefficients.

A window in which the distance from the median value of the window area increases, a smaller weight is granted will be described with reference to the following drawing.

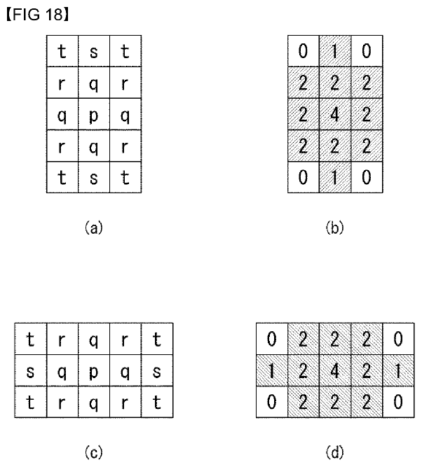

FIG. 18 is a diagram illustrating a method for applying a weight in a window area as an embodiment to which the present invention may be applied.

Referring to FIG. 18, the method will be described by assuming the case where the window having a 5×3 size or a window having a 3×5 size is used. However, the present invention is not limited thereto and the weight depending on the distance from the median value in the window area may be granted even to the window having the (2N+1)×(2M+1) size other than the 5×3 size or the 3×5 size using the same method.

Referring to FIG. 18(a), a weight p may be applied to a median value in the window having the 5×3 size and weights of q, r, s, t, and u may be sequentially applied according to the distance from the median value. Here, q, r, s, t, and u may be determined as predetermined values.

Referring FIG. 18(b), an example of a method for granting the weight in the window area having the 5×3 size is illustrated. That is, a weight 4 may be applied to the median value of the window, a weight 2 may be applied to 8 coefficients adjacent to the median value, a weight 1 may be applied to 4 coefficients in which a vertical distance from the median value is 2, and a weight 0 may be applied to the remaining coefficients.

Referring to FIG. 18(c), the weight p may be applied to the median value in the window having the 3×5 size and the weights of q, r, s, t, and u may be sequentially applied according to the distance from the median value. Here, q, r, s, t, and u may be determined as predetermined values.

Referring FIG. 18(d), an example of the method for granting the weight in the window area having the 3×5 size is illustrated. That is, a weight 4 may be applied to the median value of the window, a weight 2 may be applied to 8 coefficients adjacent to the median value, a weight 1 may be applied to 4 coefficients in which a vertical distance from the median value is 2, and a weight 0 may be applied to the remaining coefficients.

Embodiments 1 to 4 described above may be independently performed or performed by combining a plurality of embodiments, of course.

That is, for example, the size of the window may be determined according to the size and the form of the current block, it may be determined whether the gradient corresponds to the outlier component in the determined window, and the pixel-unit motion compensation may be performed using a gradient value of an area from which the outlier component is excluded.

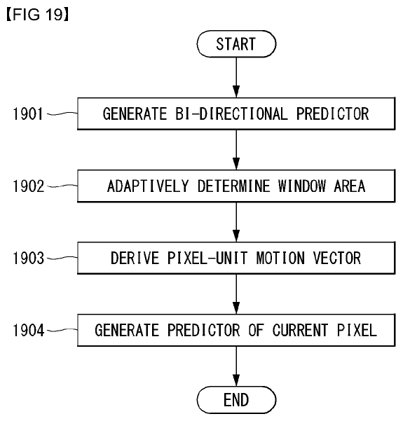

FIG. 19 is a diagram illustrating an inter prediction based image processing method according to an embodiment of the present invention.

The encoder/decoder generates a bi-directional predictor of a current pixel in a current block by performing a bi-directional inter prediction based on a motion vector of a current block (S1901).

That is, the encoder/decoder may perform motion compensation by using the inter prediction method described in FIGS. 5 to 9 above and generate the bi-directional predictor of the current pixel constituting the current block.

The encoder/decoder adaptively determines a window area centered on a pixel having a pixel having a collocated coordinate with the current pixel in a first reference block and a second reference block of the current block.

As described above, a pixel having the same coordinate as the current pixel in the current block may mean a pixel having the same coordinate as the current pixel in the first reference block in a first reference picture (i.e., reference picture 0) and the second reference block in a second reference picture (i.e., reference picture 1) identified from the motion vector of the current block. That is, the coordinate of the pixel in the reference pixel based on a left-upper pixel of the reference block (the first reference block or the second reference block) may correspond to the coordinate of the current pixel based on the left upper pixel of the current block.

Here, the window area refers to an area in which the gradient value is used in order to derive the pixel-unit motion vector.

As described above, in order to enhance the accuracy of the prediction, the encoder/decoder may use a window area from which an outlier in which the gradient component is different is excluded.

In other words, the encoder/decoder may determine a pixel in which a difference from a representative value of a gradient of an area having a predetermined size exceeds a specific threshold among pixels in the area having the predetermined size and determine the window area as an area from which the pixel in which the difference exceeds the area having the predetermined size is excluded.

Here, the area having the predetermined size refers to an area having a specific size before the outlier is removed. The area having the predetermined size may be an area having a size of (2N+1)×(2N+1) which has a square shape or an area having a size of (2N+1)×(2M+1) which has a non-square shape.

Further, as described above, the representative value of the gradient of the area having the predetermined size may be determined as any one of a mean value of the gradient of each pixel having the area having the predetermined size, a median value of the gradient of each pixel of the area having the predetermined size, and a gradient of a central pixel of the area having the predetermined size.

Further, as described above, the encoder/decoder may adaptively determine the size of the window according to the size of the current block (e.g., the coding block, the prediction block, etc.), in order to enhance the accuracy of the prediction.

As described above, by considering a window Ω_N having an adaptive size other than a 5×5 window Ω having a fixed size, the encoder/decoder may calculate S1 to S6 for calculating the optical flow motion vector (i.e., pixel-unit motion vector) by using Equation 23.

That is, the encoder/decoder may determine the window area as an area having a predefined size according to the size of the current block (e.g., the coding block, the prediction block, etc.).

In addition, the encoder/decoder may adaptively determine the size of the window for the window area according to the size of the current block among the windows having the sizes of 7×7, 5×5, and 3×3, for example.

The encoder/decoder may perform the pixel-unit motion compensation by determining the size of the window according to the size of the current block and using the gradient component in the determined window area.

Further, as described above, the encoder/decoder may adaptively determine the size of the window according to the form (or the structure and the shape) of the current block (e.g., the coding block, the prediction block, etc.), in order to enhance the accuracy of the prediction.

That is, the encoder/decoder may determine the window area as a window area having a predefined form according to the form of the current block.

In addition, the encoder/decoder may determine the window area as a window area of a non-square form when the current block is the non-square block.

As described above, when a window Ω_partType having an adaptive size other than the 5×5 window Ω having the fixed size is considered, S1 to S6 for calculating the optical flow motion vector (i.e., pixel-unit motion vector) may be calculated using Equation 24.

The encoder/decoder may perform the pixel-unit motion compensation by determining the size (or form) of the window according to the form of the current block and using the gradient component in the determined window area.

The encoder/decoder derives one motion vector in the window area by using a gradient indicating an increase/decrease rate of a pixel value in a horizontal direction or a vertical direction based on each pixel of the window area and determines the derived motion vector as a pixel-unit motion vector of the current pixel (S1903).

That is, the encoder/decoder may derive the optical flow motion vector (i.e., pixel-unit motion vector) in units of each pixel in the current block.

As described above, the encoder/decoder may calculate S1 to S6 by using any one of Equations 22 to 24. In addition, the encoder/decoder may calculate the optical flow motion vector (or the pixel-unit motion vector) using Equation 19 or 21 described above based on S1 to S6 calculated.

Further, as described above, the encoder/decoder may grant the weight depending on the distance from the median value of the window. In other words, the encoder/decoder may derive the pixel-unit motion vector by using a gradient value of each pixel to which the weight depending on the distance from a central pixel of the window area is granted.

Specifically, the encoder/decoder may perform the pixel-unit motion compensation by granting a small weight to a pixel value positioned far away from the median value of the window and granting a large weight to a pixel value positioned closer to the median value.

Here, the median value means a gradient component positioned at the center of the window having the (2N+1)×(2N+1) size. In addition, the median value may be referred to as the central pixel of the window area.

In other words, the encoder/decoder may calculate S1 to S6 using Equation 24 and calculate the optical flow motion vector (or the pixel-unit motion vector) using S1 to S6 calculated and Equation 19 or 21 described above.

The encoder/decoder generates the predictor of the current pixel by adjusting the bi-directional predictor based on the pixel-unit motion vector (S1904).

That is, the encoder/decoder may generate the predictor of the current pixel by adjusting the bi-directional predictor of the current pixel by using Equation 20 described above based on the optical flow motion vector derived in step S1903. The encoder/decoder may derive the optical flow motion vector in units of the pixel and generate a pixel-unit predictor of each pixel in the current block by using Equation 20 based on the optical flow motion vector in units of the pixel.

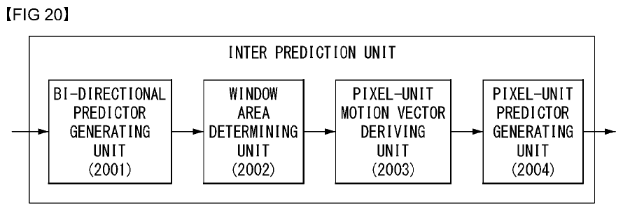

FIG. 20 is a diagram illustrating an inter prediction unit according to an embodiment of the present invention.

In FIG. 20, for convenience of description, inter prediction units 181 (see FIG. 1) and 261 (see FIG. 2) is illustrated as one block, but the inter prediction units 181 and 261 may be implemented by a configuration included in the encoder and/or the decoder.

Referring to FIG. 20, the inter prediction units 181 and 261 implement the functions, procedures, and/or methods proposed in FIGS. 5 to 19 above. Specifically, inter prediction units 181 and 261 may be configured to include a bi-directional predictor generating unit 2001, a window area determining unit 2002, a pixel-unit motion vector deriving unit 2003, and a pixel-unit predictor generating unit 2004.

The bi-directional predictor generating unit 2001 generates the bi-directional predictor of the current pixel in the current block by performing the bi-directional inter prediction based on the motion vector of the current block.

That is, the bi-directional predictor generating unit 2001 may perform motion compensation by using the inter prediction method described in FIGS. 5 to 9 above and generate the bi-directional predictor of the current pixel constituting the current block.

The window area determining unit 2002 adaptively determines a window area centered on a pixel having a pixel having a collocated coordinate with the current pixel in a first reference block and a second reference block of the current block.

As described above, a pixel having the same coordinate as the current pixel in the current block may mean a pixel having the same coordinate as the current pixel in the first reference block in a first reference picture (i.e., reference picture 0) and the second reference block in a second reference picture (i.e., reference picture 1) identified from the motion vector of the current block. That is, the coordinate of the pixel in the reference pixel based on a left-upper pixel of the reference block (the first reference block or the second reference block) may correspond to the coordinate of the current pixel based on the left upper pixel of the current block.

Here, the window area refers to an area in which the gradient value is used in order to derive the pixel-unit motion vector.

As described above, in order to enhance the accuracy of the prediction, the window area determining unit 2002 may use a window area from which an outlier in which the gradient component is different is excluded.

In other words, the window area determining unit 2002 may determine a pixel in which a difference from a representative value of a gradient of an area having a predetermined size exceeds a specific threshold among pixels in the area having the predetermined size and determine the window area as an area from which the pixel in which the difference exceeds the area having the predetermined size is excluded.

Here, the area having the predetermined size refers to an area having a specific size before the outlier is removed. The area having the predetermined size may be an area having a size of (2N+1)×(2N+1) which has a square shape or an area having a size of (2N+1)×(2M+1) which has a non-square shape.

Further, as described above, the representative value of the gradient of the area having the predetermined size may be determined as any one of a mean value of the gradient of each pixel having the area having the predetermined size, a median value of the gradient of each pixel of the area having the predetermined size, and a gradient of a central pixel of the area having the predetermined size.

Further, as described above, the window area determining unit 2002 may adaptively determine the size of the window according to the size of the current block (e.g., the coding block, the prediction block, etc.), in order to enhance the accuracy of the prediction.

As described above, by considering the window Ω_N having the adaptive size determined by the window area determining unit 2002, which is other than the 5×5 window Ω having the fixed size, S1 to S6 for calculating the optical flow motion vector (i.e., pixel-unit motion vector) may be calculated by using Equation 23.

That is, the window area determining unit 2002 may determine the window area as an area having a predefined size according to the size of the current block (e.g., the coding block, the prediction block, etc.).

In addition, the window area determining unit 2002 may adaptively determine the size of the window for the window area according to the size of the current block among the windows having the sizes of 7×7, 5×5, and 3×3, for example.

The window area determining unit 2002 may perform the pixel-unit motion compensation by determining the size of the window according to the size of the current block and using the gradient component in the determined window area.

Further, as described above, the window area determining unit 2002 may adaptively determine the size of the window according to the form (or the structure and the shape) of the current block (e.g., the coding block, the prediction block, etc.), in order to enhance the accuracy of the prediction.

That is, the window area determining unit 2002 may determine the window area as a window area having a predefined form according to the form of current block.

In addition, the window area determining unit 2002 may determine the window area as a window area of a non-square form when the current block is the non-square block.

As described above, when a window Ω_partType having an adaptive size other than the 5×5 window Ω having the fixed size is considered, S1 to S6 for calculating the optical flow motion vector (i.e., pixel-unit motion vector) may be calculated using Equation 24.

The window area determining unit 2002 may perform the pixel-unit motion compensation by determining the size (or form) of the window according to the form of the current block and using the gradient component in the determined window area.

The pixel-unit motion vector deriving unit 2003 derives one motion vector in the window area by using a gradient indicating an increase/decrease rate of a pixel value in a horizontal direction or a vertical direction based on each pixel of the window area and determines the derived motion vector as a pixel-unit motion vector of the current pixel.

The pixel-unit motion vector deriving unit 2003 may derive the optical flow motion vector (i.e., pixel-unit motion vector) in units of each pixel in the current block.

As described above, the pixel-unit motion vector deriving unit 2003 may calculate S1 to S6 by using any one of Equations 22 to 24. In addition, the pixel-unit motion vector deriving unit 2003 may calculate the optical flow motion vector (or the pixel-unit motion vector) using Equation 19 or 21 described above based on S1 to S6 calculated.

Further, as described above, the pixel-unit motion vector deriving unit 2003 may grant the weight depending on the distance from the median value of the window at the time of calculating S1 to S6. In other words, the pixel-unit motion vector deriving unit 2003 may derive the pixel-unit motion vector by using a gradient value of each pixel to which the weight depending on the distance from a central pixel of the window area is granted.

Specifically, the pixel-unit motion vector deriving unit 2003 may perform the pixel-unit motion compensation by granting a small weight to a pixel value positioned far away from the median value of the window and granting a large weight to a pixel value positioned closer to the median value.

Here, the median value means a gradient component positioned at the center of the window having the (2N+1)×(2N+1) size. In addition, the median value may be referred to as the central pixel of the window area.

In other words, the pixel-unit motion vector deriving unit 2003 may calculate S1 to S6 using Equation 24 and calculate the optical flow motion vector (or the pixel-unit motion vector) using S1 to S6 calculated and Equation 19 or 21 described above.

The pixel-unit predictor generating unit 2004 generates the predictor of the current pixel by adjusting the bi-directional predictor based on the pixel-unit motion vector.

That is, the pixel-unit predictor generating unit 2004 may generate the predictor of the current pixel by adjusting the bi-directional predictor of the current pixel by using Equation 20 described above based on the optical flow motion vector derived by the pixel-unit motion vector deriving unit 2003. The pixel-unit predictor generating unit 2004 may derive the optical flow motion vector in units of the pixel and generate a pixel-unit predictor of each pixel in the current block by using Equation 20 based on the optical flow motion vector in units of the pixel.

In the embodiments described above, the components and the features of the present invention are combined in a predetermined form. Each component or feature should be considered as an option unless otherwise expressly stated. Each component or feature may be implemented not to be associated with other components or features. Further, the embodiment of the present invention may be configured by associating some components and/or features. The order of the operations described in the embodiments of the present invention may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present invention may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present invention may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present invention may be embodied in other specific forms without departing from essential characteristics of the present invention. Accordingly, the aforementioned detailed description should not be construed as restrictive in all terms and should be exemplarily considered. The scope of the present invention should be determined by rational construing of the appended claims and all modifications within an equivalent scope of the present invention are included in the scope of the present invention.

### INDUSTRIAL APPLICABILITY

Hereinabove, the preferred embodiments of the present invention are disclosed for an illustrative purpose and hereinafter, modifications, changes, substitutions, or additions of various other embodiments will be made within the technical spirit and the technical scope of the present invention disclosed in the appended claims by those skilled in the art.

1. A method for processing an image based on an inter prediction, the method comprising:
generating a bi-directional predictor of a current pixel in a current block by performing a bi-directional inter prediction based on a motion vector of the current block;
adaptively determining a window area centered on a pixel having a pixel having a collocated coordinate with the current pixel in a first reference block and a second reference block of the current block;
deriving one motion vector in the window area by using a gradient indicating an increase/decrease rate of a pixel value in a horizontal direction or a vertical direction based on each pixel of the window area and determining the derived motion vector as a pixel-unit motion vector of the current pixel; and
generating a predictor of the current pixel by adjusting the bi-directional predictor based on the pixel-unit motion vector.

2. The method for processing an image based on an inter prediction of claim 1, wherein the adaptively determining of the window area further includes determining a pixel in which a difference between a gradient and a representative value of a gradient having an area having a predetermined size exceeds a specific threshold value among pixels in the area having the predetermined size centered on the current pixel, and
wherein the window area is determined as an area from which the pixel in which the difference exceeds the threshold value in the area having the predetermined size is excluded.

3. The method for processing an image based on an inter prediction of claim 2, wherein the representative value of the gradient of the area having the predetermined size is any one of a mean value of the gradient of each pixel having the area having the predetermined size, a median value of the gradient of each pixel of the area having the predetermined size, and a gradient of a central pixel of the area having the predetermined size.

4. The automated guided vehicle control system of claim 2, wherein in the determining of the pixel in which the difference exceeds the specific threshold value, the pixel in which the difference exceeds the specific threshold value is determined except for a part duplicated with the area having the predetermined size centered on a pixel adjacent to the current pixel from the area having the predetermined size centered on the current pixel.

5. The method for processing an image based on an inter prediction of claim 1, wherein the window area is determined as an area having a predefined size according to the size of the current block.

6. The method for processing an image based on an inter prediction of claim 1, wherein the window area is determined as an area having any one size of 3×3, 5×5, and 7×7 according to the size of the current block.

7. The method for processing an image based on an inter prediction of claim 1, wherein the window area is determined as an area having a predefined form according to the form of the current block.

8. The method for processing an image based on an inter prediction of claim 1, wherein when the current block is a non-square block, the window area is determined as a non-square area.

9. The method for processing an image based on an inter prediction of claim 1, wherein the pixel-unit motion vector is derived from the gradient of each pixel to which a weight depending on a distance from the central pixel of the window area is granted.

10. An apparatus for processing an image based on an inter prediction, the apparatus comprising:
a bi-directional predictor generation unit generating a bi-directional predictor of a current pixel in a current block by performing a bi-directional inter prediction based on a motion vector of the current block;
a window area determination unit adaptively determining a window area centered on a pixel having a pixel having a collocated coordinate with the current pixel in a first reference block and a second reference block of the current block;
a pixel-unit motion vector determination unit deriving one motion vector in the window area by using a gradient indicating an increase/decrease rate of a pixel value in a horizontal direction or a vertical direction based on each pixel of the window area and determining the derived motion vector as a pixel-unit motion vector of the current pixel; and
a pixel-unit predictor generation unit generating a predictor of the current pixel by adjusting the bi-directional predictor based on the pixel-unit motion vector.
